(19) United States
(12) Patent Application Publication
(10) Pub. No.: US 2023/0257853 A1
(43) Pub. Date: Aug. 17, 2023

(54) Aluminum Alloys Having a High Amount of Recycled Material

(71) Applicant: Kaiser Aluminum Warrick, LLC, Newburgh, IN (US)

(72) Inventors: Phillip A. Hollinshead, Winchester, VA (US); Courtney Burden, Evansville, IN (US); Thomas N. Rouns, Pittsburgh, PA (US); Eileen Kenzevich, Apollo, PA (US)

(21) Appl. No.: 18/107,727

(22) Filed: Feb. 9, 2023

Related U.S. Application Data
(60) Provisional application No. 63/309,305, filed on Feb. 11, 2022.

(51) Int. Cl. C22B 21/00; C22C 21/08; C21D 9/46

(52) U.S. Cl. CPC C22B 21/0092; C22C 21/08; C21D 9/46

(57) ABSTRACT

An aluminum alloy sheet includes an aluminum alloy composition. The aluminum alloy composition includes: a first component; and a second component. The first component includes recycled material and the second component includes non-recycled material. The aluminum alloy composition includes a recycled content of at least 50%. The ultimate tensile strength of the aluminum alloy sheet is from 37 ksi to 52 ksi and the tensile yield strength of the aluminum alloy sheet is from 34 ksi to 47 ksi. An aluminum alloy composition, a method of making an aluminum alloy sheet, a method of making an aluminum package, and a method of making an aluminum alloy composition are also provided.

### CROSS REFERENCE TO RELATED APPLICATION

This application claims priority to U.S. Provisional Application No. 63/309,305, filed on Feb. 11, 2022, the disclosure of which is incorporated by reference in its entirety.

### BACKGROUND OF THE INVENTION

### Field of the Invention

This invention relates to aluminum alloy compositions that include at least 50% recycled content, aluminum alloy sheets produced from aluminum alloy compositions that include at least 50% recycled content, and methods of making the aluminum alloy sheet and aluminum packages.

### Technical Considerations

Aluminum alloys are widely used in the manufacture of aluminum containers, such as beverage cans and food cans. These aluminum alloys must be formable enough and strong enough to withstand the processes for forming the final aluminum container, the processes for food processing within the container, and distribution.

Aluminum containers and aluminum scrap from industrial processes can be recycled and used to prepare other aluminum products. For example, used beverage can (UBC) scrap is aluminum scrap that is collected from used beverage cans, and can include a mixture of several different aluminum alloys. Aluminum scrap from industrial processes, such as from building, transportation, and printing processes, can also be recycled. Like UBC, scrap from industrial processes can also include a mixture of several different aluminum alloys. The aluminum scrap from UBC and industrial processes can be combined, processed, melted, and then used for producing new aluminum products. However, this aluminum scrap can include impurities and/or undesirable amounts of alloying components.

### SUMMARY OF THE INVENTION

To achieve the appropriate balance of alloying components, material strength, and formability, aluminum scrap can be combined with sufficient amounts of prime aluminum and alloying elements. It would be desirable to produce an aluminum alloy composition that uses high amounts of aluminum scrap material and low amounts of prime aluminum and alloying elements that can be used to form an aluminum alloy sheet that meets the formability and strength requirements for manufacturing and processing aluminum containers.

The invention relates to an aluminum alloy sheet. The aluminum alloy sheet comprises an aluminum alloy composition. The aluminum alloy composition comprises a first component; a second component; and an optional third component. The first component comprises recycled material, the second component comprises non-recycled material, and the third component (if present) comprises mill scrap. The aluminum alloy composition comprises a recycled content of at least 50%. The ultimate tensile strength of the aluminum alloy sheet is from 37 ksi to 52 ksi and the tensile yield strength of the aluminum alloy sheet is from 34 ksi to 47 ksi.

The invention relates to an aluminum alloy sheet. The aluminum alloy sheet comprises an aluminum alloy composition. The aluminum alloy composition comprises a first component; a second component; and an optional third component. The first component comprises recycled material, the second component comprises non-recycled material, and the third component (if present) comprises mill scrap. The aluminum alloy composition comprises a recycled content of at least 50%. The aluminum alloy sheet is a coated aluminum alloy sheet. The ultimate tensile strength of the coated aluminum alloy sheet is from 37 ksi to 52 ksi and the tensile yield strength of the coated aluminum alloy sheet is from 34 ksi to 47 ksi.

The invention also relates to an aluminum alloy composition. The aluminum alloy composition comprises a first component; a second component; and an optional third component. The first component comprises recycled material, the second component comprises non-recycled material, and the third component (if present) comprises mill scrap. The aluminum alloy composition comprises at least 50% recycled content and comprises not greater than 0.60 wt. % silicon; not greater than 0.80 wt. % iron; from 0.05 wt. % to 0.30 wt. % copper; from 0.80 wt. % to 2.60 wt. % magnesium; from 0.60 wt. % to 1.40 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

The invention also relates to a method of making an aluminum alloy sheet. The method comprises: providing an aluminum alloy composition, wherein the aluminum alloy composition comprises: a first component; a second component; and an optional third component, wherein the first component comprises recycled material, the second component comprises non-recycled material, the third component (if present) comprises mill scrap, and the aluminum alloy composition comprises a recycled content of at least 50%; casting the aluminum alloy composition to produce an aluminum alloy ingot; rolling the aluminum alloy ingot to produce an aluminum alloy sheet; and coating the aluminum alloy sheet to form a coated aluminum alloy sheet. The ultimate tensile strength of the coated aluminum alloy sheet is from 37 ksi to 52 ksi and the tensile yield strength of the coated aluminum alloy sheet is from 34 ksi to 47 ksi.

The invention also relates to a method of making an aluminum package. The method comprises: obtaining an aluminum alloy sheet, wherein the aluminum alloy sheet comprises an aluminum alloy composition comprising: a first component; a second component; and an optional third component, wherein the first component comprises recycled material, the second component comprises non-recycled material, the optional third component (if present) comprises mill scrap, and the aluminum alloy composition comprises a recycled content of at least 50%; and forming the aluminum alloy sheet into an aluminum alloy package. The ultimate tensile strength of the aluminum alloy sheet is from 37 ksi to 52 ksi and the tensile yield strength of the aluminum alloy sheet is from 34 ksi to 47 ksi.

The invention also relates to a method of making an aluminum package. The method comprises: obtaining an aluminum alloy sheet, wherein the aluminum alloy sheet comprises an aluminum alloy composition comprising: a first component; a second component; and an optional third component; wherein the first component comprises recycled material, the second component comprises non-recycled material, the optional third component (if present) comprises mill scrap, and the aluminum alloy composition comprises a recycled content of at least 50%; coating the aluminum alloy sheet to form a coated aluminum alloy sheet; and forming the coated aluminum alloy sheet into an aluminum alloy package. The ultimate tensile strength of the coated aluminum alloy sheet is from 37 ksi to 52 ksi and the tensile yield strength of the coated aluminum alloy sheet is from 34 ksi to 47 ksi.

The invention also relates to a method of making an aluminum alloy composition. The method comprises: obtaining a first component, wherein the first component comprises recycled material; obtaining a second component, wherein the second component comprises non-recycled material; melting the first component; melting the second component; and blending the first component and the second component together to form the aluminum alloy composition, wherein the aluminum alloy composition comprises a recycled content of at least 50%, and comprises: not greater than 0.60 wt. % silicon; not greater than 0.80 wt. % iron; from 0.05 wt. % to 0.30 wt. % copper; from 0.80 wt. % to 2.60 wt. % magnesium; from 0.60 wt. % to 1.40 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

### BRIEF DESCRIPTION OF THE DRAWINGS

FIGS. 1A-1C are box plots of the ultimate tensile strength, tensile strength, and percent elongation, respectively. FIG. 1A is a box plot of the ultimate tensile strength of Experimental Aluminum Alloy 1-1 and Experimental Aluminum Alloy 1-2 having 80% recycled content as compared to a Reference aluminum alloy having a recycled content of 46%. FIG. 1B is a box plot of the tensile yield strength of Experimental Aluminum Alloy 1-1 and Aluminum Alloy 1-2 having 80% recycled content as compared to a Reference aluminum alloy having an average recycled content of 46%. FIG. 1C is a box plot of the percent elongation of Experimental Aluminum Alloy 1-1 and Aluminum Alloy 1-2 having 80% recycled content as compared to a Reference aluminum alloy having an average recycled content of 46%.

FIGS. 2A-2F are photographs of drawn and redrawn cups. The cups were drawn from a sheet of the Reference aluminum alloy (FIG. 2A), the aluminum sheet coil of Aluminum Alloy 1-1 (FIG. 2B), and the aluminum sheet coil of Aluminum Alloy 1-2 (FIG. 2C). The cups of the Reference aluminum alloy, the Aluminum Alloy 1-1, and the Aluminum Alloy 2-1 were then redrawn, as shown in FIGS. 2D, 2E, and 2F, respectively.

FIGS. 3A-3C are box plots of the ultimate tensile strength, tensile strength, and percent elongation, respectively. FIG. 3A is a box plot of the ultimate tensile strength of Experimental Aluminum Alloy 2-1 and Experimental Aluminum Alloy 2-2 having 70% recycled content as compared to a Reference aluminum alloy having an average recycled content of 46%. FIG. 3B is a box plot of the tensile yield strength of Experimental Aluminum Alloy 2-1 and Aluminum Alloy 2-2 having 70% recycled content as compared to a Reference aluminum alloy having an average recycled content of 46%. FIG. 3C is a box plot of the percent elongation of Experimental Aluminum Alloy 2-1 and Aluminum Alloy 2-2 having 70% recycled content as compared to a Reference aluminum alloy having an average recycled content of 46%.

FIGS. 4A-4D are photographs of drawn and redrawn cups. The cups were drawn from the aluminum sheet coil of Aluminum Alloy 2-1 (FIG. 4A) and the aluminum sheet coil of Aluminum Alloy 2-2 (FIG. 4B). The cups of the Aluminum Alloy 2-1 and the Aluminum Alloy 2-2 were then redrawn, as shown in FIGS. 4C and 4D, respectively.

### DESCRIPTION OF THE INVENTION

It is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

As used herein, reference is made to alloys identified by aluminum industry designations, such as “series” or “3xxx.” For an understanding of the number designation system most commonly used in naming and identifying aluminum and its alloys, see “International Alloy Designations and Chemical Composition Limits for Wrought Aluminum and Wrought Aluminum Alloys” published by The Aluminum Association. The tempers mentioned herein are as defined by the American National Standard Alloy and Temper Designation System for Aluminum ANSI H35.1.

The present invention relates to an aluminum alloy sheet. The aluminum alloy sheet comprises an aluminum alloy composition comprising a first component and a second component. The first component comprises recycled material and the second component comprises non-recycled material. The aluminum alloy composition comprises a recycled content of at least 50%. The ultimate tensile strength of the aluminum alloy sheet is from 37 ksi to 52 ksi and the tensile yield strength of the aluminum alloy sheet is from 34 ksi to 47 ksi.

The aluminum alloy composition used to form an aluminum alloy sheet may further comprise a third component. The optional third component comprises mill scrap. The amount of the third component is not included when determining the percentage of recycled content. Regardless of whether the third component is added, the ultimate tensile strength of the aluminum alloy sheet is still in the range from 37 ksi to 52 ksi, and the tensile yield strength of the aluminum alloy sheet is still in the range from 34 ksi to 47 ksi.

The present invention also relates to a coated aluminum alloy sheet, where both sides of the aluminum alloy sheet are coated. The coated aluminum alloy sheet comprises an aluminum alloy composition comprising a first component and a second component. The first component comprises recycled material and the second component comprises non-recycled material. The aluminum alloy composition comprises a recycled content of at least 50%. The ultimate tensile strength of the coated aluminum alloy sheet is from 37 ksi to 52 ksi and the tensile yield strength of the coated aluminum alloy sheet is from 34 ksi to 47 ksi.

The aluminum alloy composition used to form a coated aluminum alloy sheet may further comprise a third component. The third component comprises mill scrap. The amount of the third component is not included when determining the percentage of recycled content. Regardless of whether the third component is added, the ultimate tensile strength of the coated aluminum alloy sheet is still in the range from 37 ksi to 52 ksi, and the tensile yield strength of the coated aluminum alloy sheet is still in the range from 34 ksi to 47 ksi.

The present invention also relates to an aluminum alloy composition. The aluminum alloy composition comprises a first component and a second component. The first component comprises recycled material and the second component comprises non-recycled material. The aluminum alloy composition comprises a recycled content of at least 50%. The aluminum alloy composition comprises not greater than 0.60 wt. % silicon; not greater than 0.80 wt. % iron; from 0.05 wt. % to 0.30 wt. % copper; from 0.80 wt. % to 2.60 wt. % magnesium; from 0.60 wt. % to 1.40 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

The aluminum alloy compositions described herein may consist essentially of a first component and a second component. The aluminum alloy compositions described herein may consist of a first component and a second component.

The aluminum alloy composition may further comprise a third component. The third component comprises mill scrap. The amount of the third component is not included when determining the percentage of recycled content. Regardless of whether third component is added, the aluminum alloy composition still has the alloying elements within the ranges provided herein.

As used herein, “tensile yield strength” is defined as the load at 0.2% offset yield divided by the original cross sectional area of the specimen. As used herein, the “ultimate tensile strength” is the maximum load divided by the original cross sectional area.

The aluminum alloy composition comprises a recycled content. As used herein, “recycled content” is the amount, by mass, of material in the aluminum alloy composition that was obtained from recycled aluminum and recycled aluminum alloys, referred to in this application as the first component. The recycled content is a percentage that is calculated by dividing the weight of the first component by the sum of the weight of the first component and the second component. The recycled content does not include the amount of the third component, as indicated by the Aluminum Association.

The recycled content of the aluminum alloy composition may be at least 50%, such as at least 55%, such as at least 60%, such as at least 65%, such as at least 70%, such as at least 71%, such as at least 75%, such as at least 78%, such as at least 80%, such as at least 81%, such as at least 85%, such as at least 90%, such as at least 95%, or such as 100%. The recycled content of the aluminum alloy composition may be from 50% to 100%, such as from 50% to 95%, such as from 50% to 90%, such as from 50% to 85%, such as from 50% to 80%, such as from 50% to 75%, such as from 50% to 70%, such as from 50% to 65%, such as from 50% to 60%, such as from 50% to 55%, such as from 55% to 100%, such as from 55% to 95%, such as from 55% to 90%, such as from 55% to 85%, such as from 55% to 80%, such as from 55% to 75%, such as from 55% to 70%, such as from 55% to 65%, such as from 55% to 60%, such as from 60% to 100%, such as from 60% to 95%, such as from 60% to 90%, such as from 60% to 85%, such as from 60% to 80%, such as from 60% to 75%, such as from 60% to 70%, such as from 60% to 65%, such as from 65% to 100%, such as from 65% to 95%, such as from 65% to 90%, such as from 65% to 85%, such as from 65% to 80%, such as from 65% to 75%, such as from 65% to 70%, such as from 70% to 100%, such as from 70% to 95%, such as from 70% to 90%, such as from 70% to 85%, such as from 70% to 80%, such as from 70% to 75%, such as such as from 75% to 100%, such as from 75% to 95%, such as from 75% to 90%, such as from 75% to 85%, such as from 75% to 80%, such as from 80% to 100%, such as from 80% to 95%, such as from 80% to 90%, or such as from 80% to 85%.

The recycled material of the first component may comprise one or more 5xxx series aluminum alloys that have been collected as scrap. For example, the recycled material of the first component may include, but is not limited to: scrap Aluminum Association (AA) 5457, scrap AA 5754, scrap AA 5085, scrap AA 5083, scrap AA 5052, scrap AA 5154, scrap AA 5352, scrap AA 5182, scrap AA 5042, scrap AA 5086, and combinations thereof. The recycled material of the first component may comprise post-industrial scrap, post-consumer scrap, Class I scrap, Class II scrap, Class III scrap, Class IV scrap, used beverage cans (UBCs), and combinations thereof. The recycled material of the first component may comprise scrap AA 5457, scrap AA 5754, scrap AA 5085, scrap AA 5083, scrap AA 5052, scrap AA 5154, scrap AA 5352, scrap AA 5182, scrap AA 5042, scrap AA 5086, post-industrial scrap, post-consumer scrap, Class I scrap, Class II scrap, Class III scrap, Class IV scrap, used beverage cans, and combinations thereof. The recycled content of the first component may comprise UBCs. The recycled material of the first component may comprise UBCs and scrap AA 5457.

As used herein, “post-industrial scrap” refers to aluminum and aluminum alloy scrap that is collected from an external metal processing facility or an external metal working facility. Post-industrial scrap may include aluminum sheets, cast aluminum products, aluminum wire, and other aluminum materials. The post-industrial scrap may include remelted ingot scrap, Class I scrap, Class II scrap, Class III scrap, and Class IV scrap. As used herein, “Class I scrap” refers to clean, body stock of the 3xxx series type and can include skeletons and trim, slitter balls and trim, and undecorated cans and cups. As used herein “Class II scrap” refers to 5xxx series alloys and can include skeletons and trims, slitter balls and trim, spoiled uncompounded ends, spoiled cans and cups, tab stock skeletons and particles, and mis-lithographed sheets. As used herein, “Class III scrap” refers to spoiled, decorated cans of AA the 3xxx series type. As used herein, “Class IV scrap” refers to spoiled compounded ends of the 5xxx series type.

As used herein “post-consumer scrap” refers to aluminum and aluminum alloys that can be collected, for example, from a recycling facility, and may comprise but is not limited to aluminum packaging materials, painted aluminum building materials (e.g. siding), food containers, beverage containers, or combinations thereof. Post-consumer scrap comprises UBCs. As used herein, “UBCs” are packaging materials made primarily of aluminum that are collected and sorted by a recycling facility, where the cans have been used by the consumer and are free of the beverage contents.

The scrap AA 5457, scrap AA 5754, scrap AA 5085, scrap AA 5083, scrap AA 5052, scrap AA 5154, scrap AA 5352, scrap AA 5182, scrap AA 5042, scrap AA 5086, post-industrial scrap, post-consumer scrap, Class I scrap, Class II scrap, Class III scrap, Class IV scrap, used beverage cans (UBC), and combinations thereof may be melted and blended together to form the first component.

The second component comprises non-recycled material. The non-recycled material may comprise, but is not limited to prime aluminum, an alloying element, or combinations thereof. The prime aluminum is smelted metal, such as P1020 aluminum.

The alloying element may comprise, but is not limited to, silicon (Si), iron (Fe), copper (Cu), magnesium (Mg), manganese (Mn), titanium (Ti), chromium (Cr), nickel (Ni), zinc (Zn), silver (Ag), boron (B), bismuth (Bi), gallium (Ga), lithium (Li), lead (Pb), vanadium (V), zirconium (Zr), or combinations thereof.

The non-recycled material may comprise prime aluminum and an alloying element. The non-recycled component may comprise prime aluminum and may not comprise an alloying element. The non-recycled component may comprise an alloying element and may not comprise prime aluminum.

The third component comprises mill scrap. As used herein, “mill scrap” refers to scrap aluminum and aluminum alloy materials that are generated during an internal industrial process or an internal manufacturing process, including defective or rejected products, and are subsequently internally collected. The mill scrap may comprise, but is not limited to ingot scrap, casting scrap, remelted scrap ingot (RSI), hot roll processing scrap, cold roll processing scrap, uncoated coil scrap, coated coil, and combinations thereof. Mill scrap is not considered part of the first component or the second component.

The aluminum alloy composition may comprise 100 weight percent (wt. %) of the first component, 0 wt. % of the second component, and 0 wt. % of the third component (i.e. the entire aluminum alloy composition is made from recycled material). The aluminum alloy composition may comprise the first component in an amount from 50 wt. % to 100 wt. %, such as from 60 wt. % to 100 wt. %, such as from 70 wt. % to 100 wt. %, the second component in an amount from 0 wt. % to 50 wt. %, such as from 0 wt. % to 40 wt. %, such as from 0 wt. % to 30 wt. %, and 0 wt. % of the third component (e.g. there is no mill scrap added to form the aluminum alloy composition). The aluminum alloy composition may comprise the first component in an amount from 50 wt. % to 100 wt. %, the third component in an amount from 0 wt. % to 50 wt. % and 0 wt. % of the second component (e.g. there is no prime aluminum or alloying element added to form the aluminum alloy composition).

The aluminum alloy composition may comprise the first component in an amount of from 40 wt. % to 95 wt. %, such as from 40 wt. % to 90 wt. %, such as from 40 wt. % to 80 wt. %, or such as from 45 wt. % to 95 wt. %; the second component in an amount of from 5 wt. % to 25 wt. %, or such as from 10 wt. % to 25 wt. %; and the optional third component (if present) in an amount of from 0 wt. % to 35 wt. %, such as from 0 wt. % to 30 wt. %, such as from 5 wt. % to 35 wt. %, or such as from 10 wt. % to 35 wt. %, based on 100 wt. % of the aluminum alloy composition.

The combination of the first component comprising recycled material, the second component comprising non-recycled material, and the optional third component comprising mill scrap may form an aluminum alloy composition that comprises Si in an amount not greater than 0.60 wt. % (for example from 0.15 wt. % to 0.60 wt. %), Fe in an amount not greater than 0.80 wt. % (for example from 0.34 wt. % to 0.80 wt. %), Cu in an amount from 0.05 wt. % to 0.30 wt. %, Mg in an amount from 0.80 wt. % to 2.60 wt. %, Mn in an amount from 0.60 wt. % to 1.40 wt. %, Ti in an amount not greater than 0.10 wt. % (for example from 0.007 wt. % to 0.10 wt. %), not greater than 0.3 wt. % Cr, Zn in an amount that is not greater than 0.30 wt. %, Ga in an amount that is not greater than 0.05 wt. %, not greater than 0.15 wt. % other elements, and the balance is Al to obtain an elemental composition of 100 wt. %. As used herein, “other elements” refers to elements that are not intentionally added to the aluminum alloy composition and may comprise, but are not limited to sodium, calcium, and combinations thereof. Each of the other elements alone may not be greater than 0.05 wt. % of the aluminum alloy composition. The aluminum alloy composition may be used to form an aluminum alloy sheet or a coated aluminum alloy sheet, where the aluminum alloy sheet or the coated aluminum alloy sheet may have a UTS in the range of from 37 ksi to 52 ksi, a TYS in the range from 34 ksi to 47 ksi, and a percent elongation of at least 4%, or such as from 4% to 12%.

The combination of the first component comprising recycled material, the second component comprising non-recycled material, and the optional third component comprising mill scrap may form an aluminum alloy composition that comprises from Si in an amount not greater than 0.60 wt. %, such as not greater than 0.40 wt. %, such as from 0.15 wt. % to 0.27 wt. %, or such as from 0.17 wt. % to 0.25 wt. %; Fe in an amount from not greater than 0.80 wt. %, not greater than 0.70 wt. %, such as from 0.34 wt. % to 0.50 wt. %, or such as from 0.38 wt. % to 0.48 wt. %; Cu in an amount from 0.05 wt. % to 0.30 wt. %, such as from 0.14 wt. % to 0.24 wt. %, or such as from 0.15 wt. % to 0.19 wt. %; Mg in an amount from 1.40 wt. % to 2.60 wt. %, such as from 1.60 wt. % to 2.60 wt. %, such as from 2.15 wt. % to 2.55 wt. %, such as from 2.30 wt. % to 2.50 wt. %, such as from 1.40 wt. % to 1.80 wt. %, such as from 1.50 wt. % to 1.70 wt. %, such as from 1.60 wt. % to 2.00 wt. %, such as from 1.70 wt. % to 1.90 wt. %, such as from 1.80 wt. % to 2.20 wt. %, or such as from 1.90 wt. % to 2.10 wt. %; Mn in an amount from 0.60 wt. % to 1.10 wt. %, such as from 0.67 wt. % to 0.83 wt. %, or such as from 0.70 wt. % to 0.80 wt. %; Ti in an amount not greater than 0.10 wt. %, such as from 0.008 wt. % to 0.055 wt. %, or such as from 0.012 wt. % to 0.018 wt. %; Cr in an amount that is not greater than 0.3 wt. %, such as not greater than 0.03 wt. %, or such as not greater than 0.02 wt. %; Zn in an amount that is not greater than 0.30 wt. %, such as not greater than 0.12 wt. %, or such as not greater than 0.090 wt. %; Ga in an amount that is not greater than 0.050 wt. %, such as not greater than 0.040 wt. %, or such as not greater than 0.015 wt. %; not greater than 0.15 wt. % other elements; and the balance is Al to obtain 100 wt. % of the aluminum alloy composition. The aluminum alloy composition may be used to form an aluminum alloy sheet. The aluminum alloy sheet may be a coated aluminum alloy sheet. The aluminum alloy sheet or the coated aluminum alloy sheet may have a UTS in the range of from 37 ksi to 52 ksi, such as from 40 ksi to 52 ksi, or such as from 43 ksi to 52 ksi; a TYS in the range from 34 ksi to 47 ksi, such as from 36 ksi to 47 ski, or such as from 37 ksi to 46 ksi; and a percent elongation of at least 4%, such as from 4% to 12%, such as from 5% to 10%, such as from 5% to 8%, or such as from 5% to 7%.

The aluminum alloy composition may comprise a recycled content of from 70% to 95%, such as from 71% to 95%, such as from 75% to 95%, such as from 78% to 95%, such as from 80% to 95%, such as from 81% to 95%, such as from 85% to 95%, or such as 100%, where the combination of the first component comprising recycled material, the second component comprising non-recycled material, and the optional third component comprising mill scrap forms an aluminum alloy composition comprising Si in an amount not greater than 0.60 wt. %, such as not greater than 0.40 wt. %, such as from 0.15 wt. % to 0.27 wt. %, or such as from 0.17 wt. % to 0.25 wt. %; Fe in an amount not greater than 0.80 wt. %, such as not greater than 0.70 wt. %, such as from 0.34 wt. % to 0.50 wt. %, or such as from 0.38 wt. % to 0.48 wt. %; Cu in an from 0.05 wt. % to 0.30 wt. %, such as from 0.14 wt. % to 0.24 wt. %, or such as from 0.15 wt. % to 0.19 wt. %; Mg in an amount from 1.40 wt. % to 2.60 wt. %, such as from 1.60 wt. % to 2.60 wt. %, such as from 2.15 wt. % to 2.55 wt. %, such as from 2.30 wt. % to 2.50 wt. %, such as from 1.40 wt. % to 1.80 wt. %, such as from 1.50 wt. % to 1.70 wt. %, such as from 1.60 wt. % to 2.00 wt. %, such as from 1.70 wt. % to 1.90 wt. %, such as from 1.80 wt. % to 2.20 wt. %, or such as from 1.90 wt. % to 2.10 wt. %; Mn in an amount from 0.60 wt. % to 1.10 wt. %, such as from 0.67 wt. % to 0.83 wt. %, or such as from 0.70 wt. % to 0.80 wt. %; Ti in an amount not greater than 0.10 wt. %, such as from 0.008 wt. % to 0.055 wt. %, or such as from 0.012 wt. % to 0.018 wt. %; Cr in an amount that is not greater than 0.30 wt. %, such as not greater than 0.03 wt. %, such as not greater than 0.02 wt. %; Zn in an amount that is not greater than 0.30 wt. %, such as not greater than 0.12 wt. %, or such as not greater than 0.090 wt. %; Ga in an amount that is not greater than 0.050 wt. %, such as not greater than 0.040 wt. %, or such as not greater than 0.015 wt. %; not greater than 0.15 wt. % other elements; and the balance is aluminum to the balance is Al to obtain an elemental composition of 100 wt. %. The aluminum alloy composition may be used to form an aluminum alloy sheet. The aluminum alloy sheet may be a coated aluminum alloy sheet. The aluminum alloy sheet or the coated aluminum alloy sheet may have a UTS in the range from 37 ksi to 52 ksi, such as from 40 ksi to 52 ksi, or such as from 43 ksi to 52 ksi; a TYS in the range from 34 ksi to 47 ksi, such as from 36 ksi to 47 ksi, or such as from 37 ksi to 46 ksi; and a percent elongation of at least 4%, such as from 4% to 12%, such as from 5% to 10%, such as from 5% to 8%, or such as from 5% to 7%.

The combination of the first component comprising recycled material, the second component comprising non-recycled material, and the optional third component comprising mill scrap may form an aluminum alloy composition that comprises Si in an amount not greater than 0.60 wt. %, such as from 0.15 wt. % to 0.27 wt. %, or such as from 0.17 wt. % to 0.25 wt. %; Fe in an amount not greater than 0.80 wt. %, such as from 0.45 wt. % to 0.55 wt. %, or such as from 0.49 wt. % to 0.54 wt. %; Cu in an amount from 0.05 wt. % to 0.25 wt. %, such as from 0.15 wt. % to 0.20 wt. %, or such as from 0.17 wt. % to 0.19 wt. %; Mg in an amount from 0.80 wt. % to 1.40 wt. %, such as from 0.80 wt. % to 1.30 wt. %, such as from 1.10 wt. % to 1.23 wt. %, or such as from 1.13 wt. % to 1.21 wt. %; Mn in an amount from 0.80 wt. % to 1.40 wt. %, such as from 0.86 wt. % to 0.98 wt. %, or such as from 0.89 wt. % to 0.96 wt. %; Ti in an amount not greater than 0.10 wt. %, such as from 0.007 wt. % to 0.020 wt. %, or such as from 0.009 wt. % to 0.018 wt. %; Cr in an amount not greater than 0.020 wt. %, or such as substantially free of chromium; Zn in an amount that is not greater than 0.25 wt. %, such as not greater than 0.12 wt. %, or such as not greater than 0.065 wt. %; Ga in an amount that is not greater than 0.050 wt. %, such as not greater than 0.040 wt. %, or such as not greater than 0.015 wt. %; not greater than 0.15 wt. % other elements; and the balance is Al to obtain an elemental composition of 100 wt. %. As used herein, “substantially free” means that the aluminum alloy composition has chromium in an amount, when measured by a quantometer, that cannot be detected, such as less than 0.0000 wt. %. The aluminum alloy composition may be used to form an aluminum alloy sheet. The aluminum alloy sheet may be a coated aluminum alloy sheet. The aluminum alloy sheet or the coated aluminum alloy sheet may have a UTS in the range of from 37 ksi to 52 ksi, such as from 38 ksi to 48 ksi, such as from 40 ksi to 45 ksi, such as from 37 ksi to 50 ksi, or such as from 37 ksi to 46 ksi; a TYS in the range from 34 ksi to 47 ksi, such as from 35 ksi to 45 ksi, such as from 37 ksi to 43 ksi, such as from 34 ksi to 45 ksi, or such as from 34 ksi to 43 ksi; and a percent elongation of at least 4%, such as from 4% to 12%, such as from 4% to 8%, or such as from 4.5% to 7%.

The aluminum alloy composition may comprise a recycled content of from 50% to 80%, such as from 50% to 75%, such as from 50% to 71%, such as from 50% to 70%, such as 50% to 90%, or such as 100%, where the combination of the first component comprising recycled material, the second component comprising non-recycled material, and the optional third component comprising mill scrap forms an aluminum alloy composition comprising from Si in an amount from not greater than 0.60 wt. %, such as from 0.15 wt. % to 0.27 wt. %, or such as from 0.17 wt. % to 0.25 wt. %; Fe in an amount not greater than 0.80 wt. %, such as from 0.45 wt. % to 0.55 wt. %, or such as from 0.49 wt. % to 0.54 wt. %; Cu in an amount from 0.05 wt. % to 0.25 wt. %, such as from 0.15 wt. % to 0.20 wt. %, or such as from 0.17 wt. % to 0.19 wt. %; Mg in an amount from 0.80 wt. % to 1.40 wt. %, such as from 0.80 wt. % to 1.30 wt. %, such as from 1.10 wt. % to 1.23 wt. %, or such as from 1.13 wt. % to 1.21 wt. %; Mn in an amount from 0.80 wt. % to 1.40 wt. %, such as from 0.86 wt. % to 0.98 wt. %, or such as from 0.89 wt. % to 0.96 wt. %; Ti in an amount not greater than 0.10 wt. %, such as from 0.007 wt. % to 0.020 wt. %, or such as from 0.009 wt. % to 0.018 wt. %; Cr in an amount not greater than 0.020 wt. %, or such as substantially free of chromium; Zn in an amount that is not greater than 0.25 wt. %, such as not greater than 0.12 wt. %, or such as not greater than 0.065 wt. %; Ga in an amount that is not greater than 0.050 wt. %, such as not greater than 0.040 wt. %, or such as not greater than 0.015 wt. %; not greater than 0.15 wt. % other elements; and the balance is Al to obtain an elemental composition of 100 wt. %. The aluminum alloy composition may be used to form an aluminum alloy sheet. The aluminum alloy sheet may be a coated aluminum alloy sheet. The aluminum alloy sheet or the coated aluminum alloy sheet may have a UTS in the range of from 37 ksi to 52 ksi, such as from 38 ksi to 48 ksi, such as from 40 ksi to 45 ksi, such as from 37 ksi to 50 ksi, or such as from 37 ksi to 46 ksi; a TYS in the range from 34 ksi to 47 ksi, such as from 35 ksi to 45 ksi, such as from 37 ksi to 43 ksi, such as from 34 ksi to 45 ksi, or such as from 34 ksi to 43 ksi; and a percent elongation of at least 4%, such as from 4% to 12%, such as from 4% to 8%, or such as from 4.5% to 7%.

The present invention also relates to a method of making an aluminum alloy sheet. The method comprises: providing an aluminum alloy composition; casting the aluminum alloy composition to produce an aluminum alloy ingot; rolling the aluminum alloy ingot to produce an aluminum alloy sheet; and coating the aluminum alloy sheet to produce a coated aluminum alloy sheet. The aluminum alloy composition comprises a first component; a second component; and an optional third component. The first component comprises recycled material, the second component comprises non-recycled material, and the optional third component (if present) comprises mill scrap. The aluminum alloy composition comprises a recycled content of at least 50%. The ultimate tensile strength of the coated aluminum alloy sheet is from 37 ksi to 52 ksi and the tensile yield strength of the coated aluminum alloy sheet is from 34 ksi to 47 ksi.

The present invention also relates to a method of making an aluminum alloy composition. The method comprises: obtaining a first component, wherein the first component comprises recycled material; obtaining a second component, wherein the second component comprises non-recycled material; melting the first component; melting the second component; and blending the first component and the second component together to form the aluminum alloy composition, wherein the aluminum alloy composition comprises a recycled content of at least 50%, and comprises: not greater than 0.60 wt. % (for example, from 0.15 wt. % to 0.60 wt. %) silicon; not greater than 0.80 wt. % Fe (for example, from 0.34 wt. % to 0.80 wt. % iron); from 0.05 wt. % to 0.30 wt. % copper; from 0.80 wt. % to 2.60 wt. % magnesium; from 0.60 wt. % to 1.40 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

The aluminum alloy composition may further comprise a third component. The third component comprises mill scrap. The amount of the third component is not included when determining the percentage of recycled content. Regardless of whether third component is added, the aluminum alloy composition still has the alloying elements within the ranges provided herein.

The first component comprising recycled material, the second component comprising non-recycled material, and the optional third component comprising mill scrap may be melted and blended together to form an aluminum alloy composition. The aluminum alloy composition may be cast into an aluminum alloy ingot. The aluminum alloy composition used to cast the ingot may be any of the aluminum alloy compositions described herein. The surface of the aluminum alloy ingot may be optionally scalped prior to the hot rolling process. The aluminum alloy ingot may be heated prior to hot rolling. The aluminum alloy ingot may not be heated prior to hot rolling. The aluminum alloy ingot is hot rolled to form an intermediate aluminum alloy sheet. The intermediate aluminum alloy sheet is then cold rolled to obtain a final aluminum alloy sheet. The final aluminum alloy sheet may have a thickness in a range of at least 0.0060 inch, such as from 0.0060 inch to 0.0130 inch, or such as from 0.0060 inch to 0.0090 inch. The aluminum alloy sheet may be thermally treated after cold rolling. The aluminum alloy sheet may not be thermally treated after cold rolling. The aluminum alloy sheet may have a H1 temper. The aluminum alloy sheet may have H2 temper. The aluminum alloy sheet may have a H3 temper. The aluminum alloy sheet may have a H4 temper. The aluminum alloy sheet is coated on both sides of the aluminum alloy sheet with a coating composition to form a coated aluminum alloy sheet. The coating composition may be any suitable coating composition. The coating composition used to form the coating may be applied by any suitable technique that replaces the air at the substrate surface with a coating, including but not limited to roll coating, spray coating, rod coating, curtain coating, gravure coating, slot coating, knife coating, extrusion coating, laminating, and combinations thereof. Following the application of the coating composition, the coated aluminum alloy sheet may be heated to facilitate the curing of the coating. The aluminum alloy sheet may be cleaned by any suitable technique prior to application of the coating composition. The aluminum alloy sheet may be pre-treated by any suitable technique after cleaning and prior to application of the coating composition. The coated aluminum alloy sheet may have a UTS in the range of from 37 ksi to 52 ksi, a TYS in the range from 34 ksi to 47 ksi, and a percent elongation of at least 4%. The coated aluminum alloy sheet may have a UTS in the range from 40 ksi to 52 ksi, or such as from 43 ksi to 52 ksi; a TYS in the range from 36 ksi to 47 ksi, or such as from 37 ksi to 46 ksi; and a percent elongation of at least 4%, such as from 4% to 12%, such as from 5% to 10%, such as from 5% to 8%, or such as from 5% to 7%. The coated aluminum alloy sheet may have a UTS in the range from 37 ksi to 50 ksi, or such as from 37 ksi to 46 ksi; a TYS in the range from 34 ksi to 45 ksi, or such as from 34 ksi to 43 ksi; and a percent elongation of at least 4%, such as from 4% to 12%, such as from 4% to 8%, or such as from 4.5% to 7%.

The present invention also is directed to a method of making an aluminum package. The method comprises: obtaining an aluminum alloy sheet and forming the aluminum alloy sheet into an aluminum alloy package. The aluminum alloy sheet comprises an aluminum alloy composition comprising a first component, a second component, and an optional third component. The first component comprises recycled material, the second component comprises non-recycled material, and the optional third component comprises mill scrap. The ultimate tensile strength of the aluminum alloy sheet is from 37 ksi to 52 ksi and the tensile yield strength of the aluminum alloy sheet is from 34 ksi to 47 ksi.

The present invention also is directed to a method of making an aluminum package. The method comprises: obtaining an aluminum alloy sheet, coating the aluminum alloy sheet to form a coated aluminum alloy sheet, and forming the coated aluminum alloy sheet into an aluminum alloy package. The aluminum alloy sheet comprises an aluminum alloy composition comprising a first component, a second component, and an optional third component. The first component comprises recycled material, the second component comprises non-recycled material, and the optional third component comprises mill scrap. The ultimate tensile strength of the coated aluminum alloy sheet is from 37 ksi to 52 ksi and the tensile yield strength of the coated aluminum alloy sheet is from 34 ksi to 47 ksi.

The aluminum alloy sheet or the coated aluminum alloy sheet formed from the aluminum alloy composition may be used to form an aluminum package, such as an aluminum package for processed food applications.

The aluminum alloy composition used to form the aluminum alloy sheet or the coated aluminum alloy sheet may be any of the aluminum alloy compositions described herein. The aluminum alloy sheet or the coated aluminum alloy sheet used to form the aluminum alloy package may be any of the aluminum alloy sheets described herein. The aluminum alloy sheet or the coated aluminum alloy sheet, formed from an aluminum alloy composition and used to form the aluminum alloy package, may comprise a UTS in the range of from 37 ksi to 52 ksi, a TYS in the range of from 34 ksi to 47 ksi, and a percent elongation of at least 4%. The aluminum alloy sheet or the coated aluminum alloy sheet, formed from an aluminum alloy composition and used to form the aluminum alloy package, may comprise a UTS in the range of from 40 ksi to 52 ksi, or such as from 43 ksi to 52 ksi; a TYS in the range of from 36 ksi to 47 ksi, or such as from 37 ksi to 46 ksi, and a percent elongation of at least 4%, such from 4% to 12%, such as from 5% to 10%, such as from 5% to 8%, or such as from 5% to 7%. The aluminum alloy sheet or coated aluminum alloy sheet, formed from the aluminum alloy composition and used to form the aluminum alloy package, may comprise a UTS in the range of from 38 ksi to 48 ksi, such as from 40 ksi to 45 ksi, 37 ksi to 50 ksi, or such as from 37 ksi to 46 ksi; a TYS in the range of from 35 ksi to 45 ksi, such as from 37 ksi to 43 ksi, such as from 34 ksi to 45 ksi, or such as from 34 ksi to 43 ksi; and a percent elongation of at least 4%, such from 4% to 12%, such as from 4% to 8%, or such as from 4.5% to 7%.

The aluminum alloy package may be an aluminum alloy food can comprising a closed bottom on one end and an open end on the other end of the can. The aluminum alloy package may be an aluminum alloy food end.

To form an aluminum alloy food can, the aluminum alloy sheet or the coated aluminum alloy sheet may be used to form an aluminum alloy blank. The aluminum alloy blank may be drawn to form the aluminum alloy food can. Alternatively, the aluminum alloy blank may be drawn and then redrawn one more times to form the aluminum alloy food can. Following drawing and/or redrawing, the closed-bottom of the aluminum alloy package may then be shaped, formed, stamped, or any combination thereof. The open end of the aluminum alloy container may be trimmed and flanged.

Alternatively, the aluminum alloy blank may be used to form an aluminum alloy food end shell. The aluminum alloy food end shell may be finished by curling. The aluminum alloy end shell may converted to have an easy opening and a tab attached to a portion of the aluminum alloy food end shell to form the aluminum alloy food end.

The following numbered clauses are illustrative of various aspects of the invention:

Clause 1: An aluminum alloy sheet comprising: an aluminum alloy composition comprising: a first component; and a second component; wherein the first component comprises recycled material, wherein the second component comprises non-recycled material, wherein the aluminum alloy composition comprises a recycled content of at least 50%; and wherein the ultimate tensile strength of the aluminum alloy sheet is from 37 ksi to 52 ksi; and wherein the tensile yield strength of the aluminum alloy sheet is from 34 ksi to 47 ksi.

Clause 2: The aluminum alloy sheet of clause 1, further comprising a third component, wherein the third component comprises mill scrap.

Clause 3: The aluminum alloy sheet of clause 1, wherein the aluminum alloy composition comprises a recycled content of at least 70%.

Clause 4: The aluminum alloy sheet of clause 1, wherein the aluminum alloy composition comprises a recycled content of at least 75%.

Clause 5: The aluminum alloy sheet of clause 1, wherein the aluminum alloy composition comprises a recycled content of at least 80%, preferably at least 85%, more preferably at least 90%, most preferably 95%.

Clause 6: The aluminum alloy sheet of any of clauses 1 to 5, wherein the recycled material of the first component is selected from the group consisting of scrap Aluminum Association (AA) 5457, scrap AA 5754, scrap AA 5085, scrap AA 5083, scrap AA 5052, scrap AA 5154, scrap AA 5352, scrap AA 5182, scrap AA 5042, scrap AA 5086, post-industrial scrap, post-consumer scrap, Class I scrap, Class II scrap, Class III scrap, Class IV scrap, used beverage cans, and combinations thereof.

Clause 7: The aluminum alloy sheet of clause 6, wherein the recycled material comprises used beverage cans.

Clause 8: The aluminum alloy sheet of clause 6, wherein the recycled material comprises used beverage cans and scrap AA 5457.

Clause 9: The aluminum alloy sheet of any of clauses 1 to 8, wherein the non-recycled material of the second component comprises prime aluminum, an alloying element, or combinations thereof.

Clause 10: The aluminum alloy sheet of clause 9, wherein the alloying element is selected from the group consisting of silicon, iron, copper, magnesium, manganese, titanium, chromium, nickel, zinc, silver, boron, bismuth, gallium, lithium, lead, tin, vanadium, zirconium, and combinations thereof.

Clause 11: The aluminum alloy sheet of clause 2, wherein the mill scrap is selected from the group consisting of ingot scrap, casting scrap, remelted scrap ingot (RSI), hot roll processing scrap, cold roll processing scrap, uncoated coil scrap, coated coil, and combinations thereof.

Clause 12: The aluminum alloy sheet of any of clauses 1 to 11, wherein the aluminum alloy composition comprises: not greater than 0.60 wt. % silicon; not greater than 0.80 wt. % iron; from 0.05 wt. % to 0.30 wt. % copper; from 0.80 wt. % to 2.60 wt. % magnesium; from 0.60 wt. % to 1.40 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 13: The aluminum alloy sheet of any of clauses 1 to 11, wherein the aluminum alloy composition comprises: not greater than 0.40 wt. % silicon; not greater than 0.70 wt. % iron; from 0.05 wt. % to 0.30 wt. % copper; from 1.60 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 14: The aluminum alloy sheet of any of clauses 1 to 11, wherein the aluminum alloy composition comprises: from 0.15 wt. % to 0.27 wt. % silicon; from 0.34 wt. % to 0.50 wt. % iron; from 0.14 wt. % to 0.24 wt. % copper; from 2.15 wt. % to 2.55 wt. % magnesium; from 0.67 wt. % to 0.83 wt. % manganese; from 0.008 wt. % to 0.055 wt. % titanium; not greater than 0.12 wt. % Zn; not greater than 0.040 wt. % Ga; not greater than 0.03 wt. % chromium; not greater than 0.15 wt. % other elements; and wherein the balance is aluminum.

Clause 15: The aluminum alloy sheet of any of clauses 1 to 11, wherein the aluminum alloy composition comprises: from 0.17 wt. % to 0.25 wt. % silicon; from 0.38 wt. % to 0.48 wt. % iron; from 0.15 wt. % to 0.19 wt. % copper; from 2.30 wt. % to 2.50 wt. % magnesium; from 0.70 wt. % to 0.80 wt. % manganese; from 0.012 wt. % to 0.018 wt. % titanium; not greater than 0.090 wt. % Zn; not greater than 0.015 wt. % Ga; not greater than 0.02 wt. % chromium; not greater than 0.15 wt. % other elements; and wherein the balance is aluminum.

Clause 16: The aluminum alloy sheet of any of clauses 1 to 11, wherein the aluminum alloy composition comprises: not greater than 0.40 wt. % silicon; not greater than 0.70 wt. % iron; from 0.05 wt. % to 0.30 wt. % copper; from 1.40 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 17: The aluminum alloy sheet of any of clauses 1 to 11, wherein the aluminum alloy composition comprises: not greater than 0.40 wt. % silicon; not greater than 0.70 wt. % iron; from 0.05 wt. % to 0.30 wt. % copper; from 1.40 wt. % to 1.80 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 18: The aluminum alloy sheet of any of clauses 1 to 11, wherein the aluminum alloy composition comprises: not greater than 0.40 wt. % silicon; not greater than 0.70 wt. % iron; from 0.05 wt. % to 0.30 wt. % copper; from 1.50 wt. % to 1.70 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 19: The aluminum alloy sheet of any of clauses 1 to 11, wherein the aluminum alloy composition comprises: not greater than 0.40 wt. % silicon; not greater than 0.70 wt. % iron; from 0.05 wt. % to 0.30 wt. % copper; from 1.60 wt. % to 2.00 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 20: The aluminum alloy sheet of any of clauses 1 to 11, wherein the aluminum alloy composition comprises: not greater than 0.40 wt. % silicon; not greater than 0.70 wt. % iron; from 0.05 wt. % to 0.30 wt. % copper; from 1.70 wt. % to 1.90 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 21: The aluminum alloy sheet of any of clauses 1 to 11, wherein the aluminum alloy composition comprises: not greater than 0.40 wt. % silicon; not greater than 0.70 wt. % iron; from 0.05 wt. % to 0.30 wt. % copper; from 1.80 wt. % to 2.20 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 22: The aluminum alloy sheet of any of clauses 1 to 11, wherein the aluminum alloy composition comprises: not greater than 0.40 wt. % silicon; not greater than 0.70 wt. % iron; from 0.05 wt. % to 0.30 wt. % copper; from 1.90 wt. % to 2.10 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 23: The aluminum alloy sheet of any of clause 1 to 11, wherein the aluminum alloy composition comprises: not greater than 0.60 wt. % silicon; greater than 0.80 wt. % iron; from 0.05 wt. % to 0.25 wt. % copper; from 0.80 wt. % to 1.30 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

Clause 24: The aluminum alloy sheet of any of clauses 1 to 11, wherein the aluminum alloy composition comprises: from 0.15 wt. % to 0.27 wt. % silicon; from 0.45 wt. % to 0.55 wt. % iron; from 0.15 wt. % to 0.20 wt. % copper; from 1.10 wt. % to 1.23 wt. % magnesium; from 0.86 wt. % to 0.98 wt. % manganese; from 0.007 wt. % to 0.020 wt. % titanium; not greater than 0.12 wt. % Zn; not greater than 0.040 wt. % Ga; not greater than 0.020 wt. % chromium; not greater than 0.15 wt. % other elements; and wherein the balance is aluminum.

Clause 25: The aluminum alloy sheet of any of clauses 1 to 11, wherein the aluminum alloy composition comprises: from 0.17 wt. % to 0.25 wt. % silicon; from 0.49 wt. % to 0.54 wt. % iron; from 0.17 wt. % to 0.19 wt. % copper; from 1.13 wt. % to 1.21 wt. % magnesium; from 0.89 wt. % to 0.96 wt. % manganese; from 0.009 wt. % to 0.018 wt. % titanium; not greater than 0.065 wt. % Zn; not greater than 0.015 wt. % Ga; not greater than 0.15 wt. % other elements; wherein the aluminum alloy composition is substantially free of chromium; and wherein the balance is aluminum.

Clause 26: The aluminum alloy sheet of any of clause 1 to 11, wherein the aluminum alloy composition comprises: not greater than 0.60 wt. % silicon; greater than 0.80 wt. % iron; from 0.05 wt. % to 0.25 wt. % copper; from 0.80 wt. % to 1.40 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

Clause 27: The aluminum alloy sheet of any of clauses 1 to 26, wherein the ultimate tensile strength of the aluminum alloy sheet is from 40 ksi to 52 ksi or is from 43 ksi to 52 ksi.

Clause 28: The aluminum alloy sheet of any of clauses 1 to 26, wherein the ultimate tensile strength of the aluminum alloy sheet is from 38 ksi to 48 ksi, from 40 ksi to 45 ksi, from 37 ksi to 50 ksi, or from 37 ksi to 46 ksi.

Clause 29: The aluminum alloy sheet of any of clauses 1 to 26, wherein the tensile yield strength of the aluminum alloy sheet is from 36 ksi to 47 ksi or from 37 ksi to 46 ksi.

Clause 30: The aluminum alloy sheet of any of clauses 1 to 26, wherein the tensile yield strength of the aluminum alloy sheet is from 35 ksi to 45 ksi, from 37 ksi to 43 ksi, from 34 ksi to 45 ksi, or from 34 ksi to 43 ksi.

Clause 31: The aluminum alloy sheet of any of clauses 1 to 26, wherein aluminum alloy sheet comprises a percent elongation is at least 4%.

Clause 32: The aluminum alloy sheet of any of clauses 1 to 31, wherein the thickness of the aluminum alloy sheet is at least 0.0060 inch.

Clause 33: The aluminum alloy sheet of any of clauses 1 to 32, wherein the aluminum alloy sheet is a coated aluminum alloy sheet.

Clause 34: An aluminum alloy composition comprising: a first component; and a second component; wherein the first component comprises recycled material, wherein the second component comprises non-recycled material; wherein the aluminum alloy composition comprises a recycled content of at least 50% and comprises not greater than 0.60 wt. % silicon; not greater than 0.80 wt. % iron; from 0.05 wt. % to 0.30 wt. % copper; from 0.80 wt. % to 2.60 wt. % magnesium; from 0.60 wt. % to 1.40 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 35: The aluminum alloy composition of clause 34, further comprising a third component, wherein the third component comprises mill scrap.

Clause 36: The aluminum alloy composition of clause 34, wherein the aluminum alloy composition comprises a recycled content of at least 70%.

Clause 37: The aluminum alloy composition of clause 34, wherein the aluminum alloy composition comprises a recycled content of at least 75%.

Clause 38: The aluminum alloy composition of clause 34, wherein the aluminum alloy composition comprises a recycled content of at least 80%, preferably at least 85%, more preferably at least 90%, most preferably 95%.

Clause 39: The aluminum alloy composition of any of clauses 34 to 38, wherein the recycled material is selected from the group consisting of scrap Aluminum Association (AA) 5457, scrap AA 5754, scrap AA 5085, scrap AA 5083, scrap AA 5052, scrap AA 5154, scrap AA 5352, scrap AA 5182, scrap AA 5042, scrap AA 5086, post-industrial scrap, post-consumer scrap, Class I scrap, Class II scrap, Class III scrap, Class IV scrap, used beverage cans, and combinations thereof.

Clause 40: The aluminum alloy composition of clause 39, wherein the recycled material comprises used beverage cans.

Clause 41: The aluminum alloy composition of clause 39, wherein the recycled material comprises used beverage cans and scrap AA 5457.

Clause 42: The aluminum alloy composition of any of clauses 34 to 41, wherein the non-recycled material of the second component comprises prime aluminum, an alloying element, or combinations thereof.

Clause 43: The aluminum alloy composition of clause 42, wherein the alloying element is selected from the group consisting of silicon, iron, copper, magnesium, manganese, titanium, chromium, nickel, zinc, silver, boron, bismuth, gallium, lithium, lead, tin, vanadium, zirconium, and combinations thereof.

Clause 44: The aluminum alloy sheet of claim 43, wherein the mill scrap is selected from the group consisting of ingot scrap, casting scrap, remelted scrap ingot (RSI), hot roll processing scrap, cold roll processing scrap, uncoated coil scrap, coated coil, and combinations thereof.

Clause 45: The aluminum alloy composition of any of clauses 34 to 44, wherein the aluminum alloy composition comprises: not greater than 0.40 wt. % silicon; not greater than 0.70 wt. % iron; from 0.05 wt. % to 0.30 wt. % copper; from 1.60 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 46: The aluminum alloy composition of any of clauses 34 to 44, wherein the aluminum alloy composition comprises: from 0.15 wt. % to 0.27 wt. % silicon; from 0.34 wt. % to 0.50 wt. % iron; from 0.14 wt. % to 0.24 wt. % copper; from 2.15 wt. % to 2.55 wt. % magnesium; from 0.67 wt. % to 0.83 wt. % manganese; from 0.008 wt. % to 0.055 wt. % titanium; not greater than 0.12 wt. % Zn; not greater than 0.040 wt. % Ga; not greater than 0.03 wt. % chromium; not greater than 0.15 wt. % other elements; and wherein the balance is aluminum.

Clause 47: The aluminum alloy composition of any of clauses 34 to 44, wherein the aluminum alloy composition comprises: from 0.17 wt. % to 0.25 wt. % silicon; from 0.38 wt. % to 0.48 wt. % iron; from 0.15 wt. % to 0.19 wt. % copper; from 2.30 wt. % to 2.50 wt. % magnesium; from 0.70 wt. % to 0.80 wt. % manganese; from 0.012 wt. % to 0.018 wt. % titanium; not greater than 0.090 wt. % Zn; not greater than 0.015 wt. % Ga; not greater than 0.02 wt. % chromium; not greater than 0.15 wt. % other elements; and wherein the balance is aluminum.

Clause 48: The aluminum alloy composition of any of clauses 34 to 44, wherein the aluminum alloy composition comprises: not greater than 0.40 wt. % silicon; not greater than 0.70 wt. % iron; from 0.05 wt. % to 0.30 wt. % copper; from 1.40 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 49: The aluminum alloy composition of any of clauses 34 to 44, wherein the aluminum alloy composition comprises: not greater than 0.40 wt. % silicon; not greater than 0.70 wt. % iron; from 0.05 wt. % to 0.30 wt. % copper; from 1.40 wt. % to 1.80 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 50: The aluminum alloy composition of any of clauses 34 to 44, wherein the aluminum alloy composition comprises: not greater than 0.40 wt. % silicon; not greater than 0.70 wt. % iron; from 0.05 wt. % to 0.30 wt. % copper; from 1.50 wt. % to 1.70 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 51: The aluminum alloy composition of any of clauses 34 to 44, wherein the aluminum alloy composition comprises: not greater than 0.40 wt. % silicon; not greater than 0.70 wt. % iron; from 0.05 wt. % to 0.30 wt. % copper; from 1.60 wt. % to 2.00 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 52: The aluminum alloy composition of any of clauses 34 to 44, wherein the aluminum alloy composition comprises: not greater than 0.40 wt. % silicon; not greater than 0.70 wt. % iron; from 0.05 wt. % to 0.30 wt. % copper; from 1.70 wt. % to 1.90 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 53: The aluminum alloy composition of any of clauses 34 to 44, wherein the aluminum alloy composition comprises: not greater than 0.40 wt. % silicon; not greater than 0.70 wt. % iron; from 0.05 wt. % to 0.30 wt. % copper; from 1.80 wt. % to 2.20 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 54: The aluminum alloy composition of any of clauses 34 to 44, wherein the aluminum alloy composition comprises: not greater than 0.40 wt. % silicon; not greater than 0.70 wt. % iron; from 0.05 wt. % to 0.30 wt. % copper; from 1.90 wt. % to 2.10 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 55: The aluminum alloy composition of any of clauses 34 to 44, wherein the aluminum alloy composition comprises: not greater than 0.60 wt. % silicon; not greater than 0.80 wt. % iron; from 0.05 wt. % to 0.25 wt. % copper; from 0.80 wt. % to 1.30 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

Clause 56: The aluminum alloy composition of any of clauses 34 to 44, wherein the aluminum alloy composition comprises: from 0.15 wt. % to 0.27 wt. % silicon; from 0.45 wt. % to 0.55 wt. % iron; from 0.15 wt. % to 0.20 wt. % copper; from 1.10 wt. % to 1.23 wt. % magnesium; from 0.86 wt. % to 0.98 wt. % manganese; from 0.007 wt. % to 0.020 wt. % titanium; not greater than 0.020 wt. % chromium; not greater than 0.12 wt. % Zn; not greater than 0.040 wt. % Ga; not greater than 0.15 wt. % other elements; and wherein the balance is aluminum.

Clause 57: The aluminum alloy composition of any of clauses 34 to 44, wherein the aluminum alloy composition comprises: from 0.17 wt. % to 0.25 wt. % silicon; from 0.49 wt. % to 0.54 wt. % iron; from 0.17 wt. % to 0.19 wt. % copper; from 1.13 wt. % to 1.21 wt. % magnesium; from 0.89 wt. % to 0.96 wt. % manganese; from 0.009 wt. % to 0.018 wt. % titanium; not greater than 0.065 wt. % Zn; not greater than 0.015 wt. % Ga; not greater than 0.15 wt. % other elements; wherein the aluminum alloy composition is substantially free of chromium; and wherein the balance is aluminum.

Clause 58: The aluminum alloy composition of any of clause 34 to 44, wherein the aluminum alloy composition comprises: not greater than 0.60 wt. % silicon; greater than 0.80 wt. % iron; from 0.05 wt. % to 0.25 wt. % copper; from 0.80 wt. % to 1.40 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

Clause 59: A method of making an aluminum alloy sheet, the method comprising: providing an aluminum alloy composition, wherein the aluminum alloy composition comprises: a first component; and a second component, wherein the first component comprises recycled material, wherein the second component comprises non-recycled material, and wherein the aluminum alloy composition comprises a recycled content of at least 50%; casting the aluminum alloy composition to produce an aluminum alloy ingot; rolling the aluminum alloy ingot to produce an aluminum alloy sheet; and coating the aluminum alloy sheet to form a coated aluminum alloy sheet, wherein the ultimate tensile strength of the coated aluminum alloy sheet is from 37 ksi to 52 ksi; and wherein the tensile yield strength of the coated aluminum alloy sheet is from 34 ksi to 47 ksi.

Clause 60: The method of clause 59, wherein the aluminum alloy composition further comprises a third component, and wherein the third component comprises mill scrap

Clause 61: The method of clause 59, wherein the aluminum alloy composition comprises a recycled content of at least 70%.

Clause 62: The method of clause 59, wherein the aluminum alloy composition comprises a recycled content of at least 75%.

Clause 63: The method of clause 59, wherein the aluminum alloy composition comprises a recycled content of at least 80%, preferably at least 85%, more preferably at least 90%, most preferably 95%.

Clause 64: The method of any of clauses 59 to 63, wherein the recycled material of the first component is selected from the group consisting of scrap Aluminum Association (AA) 5457, scrap AA 5754, scrap AA 5085, scrap AA 5083, scrap AA 5052, scrap AA 5154, scrap AA 5352, scrap AA 5182, scrap AA 5042, scrap AA 5086, post-industrial scrap, post-consumer scrap, Class I scrap, Class II scrap, Class III scrap, Class IV scrap, used beverage cans, and combinations thereof.

Clause 65: The method of clause 64, wherein the recycled material comprises used beverage cans.

Clause 66: The method of clause 64, wherein the recycled material comprises used beverage cans and scrap AA 5457.

Clause 67: The method of any of clauses 59 to 66, wherein the non-recycled material of the second component comprises prime aluminum, an alloy component, or combinations thereof.

Clause 68: The method of clause 67, wherein the alloying element is selected from the group consisting of silicon, iron, copper, magnesium, manganese, titanium, chromium, nickel, zinc, silver, boron, bismuth, gallium, lithium, lead, tin, vanadium, zirconium, and combinations thereof.

Clause 69: The method of clause 60, wherein the mill scrap is selected from the group consisting of ingot scrap, casting scrap, remelted scrap ingot (RSI), hot roll processing scrap, cold roll processing scrap, uncoated coil scrap, coated coil, and combinations thereof.

Clause 70: The method of any of clauses 59 to 69, wherein the aluminum alloy composition comprises: not greater than 0.60 wt. % silicon; not greater than 0.80 wt. % iron; from 0.05 wt. % to 0.30 wt. % copper; from 0.80 wt. % to 2.60 wt. % magnesium; from 0.60 wt. % to 1.40 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 71: The method of any of clauses 59 to 69, wherein the aluminum alloy composition comprises: not greater than 0.40 wt. % silicon; not greater than 0.70 wt. % iron; from 0.05 wt. % to 0.30 wt. % copper; from 1.60 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 72: The method of any of clauses 59 to 69, wherein the aluminum alloy composition comprises: from 0.15 wt. % to 0.27 wt. % silicon; from 0.34 wt. % to 0.50 wt. % iron; from 0.14 wt. % to 0.24 wt. % copper; from 2.15 wt. % to 2.55 wt. % magnesium; from 0.67 wt. % to 0.83 wt. % manganese; from 0.008 wt. % to 0.055 wt. % titanium; not greater than 0.12 wt. % Zn; not greater than 0.040 wt. % Ga; not greater than 0.03 wt. % chromium; not greater than 0.15 wt. % other elements; and wherein the balance is aluminum.

Clause 73: The method of any of clauses 59 to 69, wherein the aluminum alloy composition comprises: from 0.17 wt. % to 0.25 wt. % silicon; from 0.38 wt. % to 0.48 wt. % iron; from 0.15 wt. % to 0.19 wt. % copper; from 2.30 wt. % to 2.50 wt. % magnesium; from 0.70 wt. % to 0.80 wt. % manganese; from 0.012 wt. % to 0.018 wt. % titanium; not greater than 0.02 wt. % chromium; not greater than 0.090 wt. % Zn; not greater than 0.015 wt. % Ga; not greater than 0.15 wt. % other elements; and wherein the balance is aluminum.

Clause 74: The method of any of clauses 59 to 69, wherein the aluminum alloy composition comprises: not greater than 0.40 wt. % silicon; not greater than 0.70 wt. % iron; from 0.05 wt. % to 0.30 wt. % copper; from 1.40 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 75: The method of any of clauses 59 to 69, wherein the aluminum alloy composition comprises: not greater than 0.40 wt. % silicon; not greater than 0.70 wt. % iron; from 0.05 wt. % to 0.30 wt. % copper; from 1.40 wt. % to 1.80 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 76: The method of any of clauses 59 to 69, wherein the aluminum alloy composition comprises: not greater than 0.40 wt. % silicon; not greater than 0.70 wt. % iron; from 0.05 wt. % to 0.30 wt. % copper; from 1.50 wt. % to 1.70 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 77: The method of any of clauses 59 to 69, wherein the aluminum alloy composition comprises: not greater than 0.40 wt. % silicon; not greater than 0.70 wt. % iron; from 0.05 wt. % to 0.30 wt. % copper; from 1.60 wt. % to 2.00 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 78: The method of any of clauses 59 to 69, wherein the aluminum alloy composition comprises: not greater than 0.40 wt. % silicon; not greater than 0.70 wt. % iron; from 0.05 wt. % to 0.30 wt. % copper; from 1.70 wt. % to 1.90 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 79: The method of any of clauses 59 to 69, wherein the aluminum alloy composition comprises: not greater than 0.40 wt. % silicon; not greater than 0.70 wt. % iron; from 0.05 wt. % to 0.30 wt. % copper; from 1.80 wt. % to 2.20 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 80: The method of any of clauses 59 to 69, wherein the aluminum alloy composition comprises: not greater than 0.40 wt. % silicon; not greater than 0.70 wt. % iron; from 0.05 wt. % to 0.30 wt. % copper; from 1.90 wt. % to 2.10 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 81: The method of any of clauses 59 to 69, wherein the aluminum alloy composition comprises: not greater than 0.60 wt. % silicon; not greater than 0.80 wt. % iron; from 0.05 wt. % to 0.25 wt. % copper; from 0.80 wt. % to 1.30 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

Clause 82: The method of any of clauses 59 to 69, wherein the aluminum alloy composition comprises: from 0.15 wt. % to 0.27 wt. % silicon; from 0.45 wt. % to 0.55 wt. % iron; from 0.15 wt. % to 0.20 wt. % copper; from 1.10 wt. % to 1.23 wt. % magnesium; from 0.86 wt. % to 0.98 wt. % manganese; from 0.007 wt. % to 0.020 wt. % titanium; not greater than 0.020 wt. % chromium; not greater than 0.12 wt. % Zn; not greater than 0.040 wt. % Ga; not greater than 0.15 wt. % other elements; and wherein the balance is aluminum.

Clause 83: The method of any of clauses 59 to 69, wherein the aluminum alloy composition comprises: from 0.17 wt. % to 0.25 wt. % silicon; from 0.49 wt. % to 0.54 wt. % iron; from 0.17 wt. % to 0.19 wt. % copper; from 1.13 wt. % to 1.21 wt. % magnesium; from 0.89 wt. % to 0.96 wt. % manganese; from 0.009 wt. % to 0.018 wt. % titanium; not greater than 0.065 wt. % Zn; not greater than 0.015 wt. % Ga; not greater than 0.15 wt. % other elements; wherein the aluminum alloy composition is substantially free of chromium; and wherein the balance is aluminum.

Clause 84: The method of any of clause 59 to 69, wherein the aluminum alloy composition comprises: not greater than 0.60 wt. % silicon; greater than 0.80 wt. % iron; from 0.05 wt. % to 0.25 wt. % copper; from 0.80 wt. % to 1.40 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

Clause 85: The method of any of clauses 59 to 84, wherein the rolling consists of hot rolling and cold rolling.

Clause 86: The method of any of clauses 59 to 84, wherein the aluminum alloy sheet has a thickness of at least 0.006 inch.

Clause 87: The method of any of clauses 59 to 84, wherein ultimate tensile strength of the coated aluminum alloy sheet is from 40 ksi to 52 ksi, or from 43 ksi to 52 ksi.

Clause 88: The method of any of clauses 59 to 86, wherein the ultimate tensile strength of the coated aluminum alloy sheet is from 37 ksi to 50 ksi, or from 37 ksi to 46 ksi.

Clause 89: The method of any of clauses 59 to 86, wherein the tensile yield strength of the coated aluminum alloy sheet is from 36 ksi to 47 ksi, or from 37 ksi to 46 ksi.

Clause 90: The method of any of clauses 59 to 86, wherein the tensile yield strength of the coated aluminum alloy sheet is from 34 ksi to 45 ksi, or from 34 ksi to 43 ksi.

Clause 91: The method of any of clauses 59 to 86, wherein the coated aluminum alloy sheet comprises a percent elongation of at least 4%.

Clause 92: A method of making an aluminum package, the method comprising: obtaining an aluminum alloy sheet, wherein the aluminum alloy sheet comprises an aluminum alloy composition comprising: first component; and a second component; wherein the first component comprises recycled material, wherein the second component comprises non-recycled material, and wherein the aluminum alloy composition comprises a recycled content of at least 50%; wherein the ultimate tensile strength of the aluminum alloy sheet is from 37 ksi to 52 ksi; and wherein the tensile yield strength of the aluminum alloy sheet is from 34 ksi to 47 ksi; and forming the aluminum alloy sheet into an aluminum alloy package.

Clause 93: The method of clause 92, wherein the aluminum alloy composition further comprises a third component, and wherein the third component comprises mill scrap.

Clause 94: The method of clause 92, wherein the aluminum package is for processed food applications.

Clause 95: The method of clause 92, wherein the aluminum alloy composition comprises a recycled content of at least 70%.

Clause 96: The method of clause 92, wherein the aluminum alloy composition comprises a recycled content of at least 75%.

Clause 97: The method of clause 92, wherein the aluminum alloy composition comprises a recycled content of at least 80%, preferably at least 85%, more preferably at least 90%, most preferably 95%.

Clause 98: The method of any of clauses 92 to 97, wherein the recycled material of the first component is selected from the group consisting of scrap Aluminum Association (AA) 5457, scrap AA 5754, scrap AA 5085, scrap AA 5083, scrap AA 5052, scrap AA 5154, scrap AA 5352, scrap AA 5182, scrap AA 5042, scrap AA 5086, post-industrial scrap, post-consumer scrap, Class I scrap, Class II scrap, Class III scrap, Class IV scrap, used beverage cans, and combinations thereof.

Clause 99: The method of clause 98, wherein the recycled material comprises used beverage cans.

Clause 100: The method of clause 98, wherein the recycled material comprises used beverage cans and scrap AA 5457.

Clause 101: The method of any of clauses 92 to 100, wherein the non-recycled material of the second component comprises prime aluminum, an alloy component, or combinations thereof.

Clause 102: The method of clause 101, wherein the alloying element is selected from the group consisting of silicon, iron, copper, magnesium, manganese, titanium, chromium, nickel, zinc, silver, boron, bismuth, gallium, lithium, lead, tin, vanadium, zirconium, and combinations thereof.

Clause 103: The method of clause 93, wherein the mill scrap is selected from the group consisting of ingot scrap, casting scrap, remelted scrap ingot (RSI), hot roll processing scrap, cold roll processing scrap, uncoated coil scrap, coated coil, and combinations thereof.

Clause 104: The method of any of clauses 92 to 103, wherein the aluminum alloy composition comprises: not greater than 0.60 wt. % silicon; not greater than 0.80 wt. % iron; from 0.05 wt. % to 0.30 wt. % copper; from 0.80 wt. % to 2.60 wt. % magnesium; from 0.60 wt. % to 1.40 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 105: The method of any of clauses 92 to 103, wherein the aluminum alloy composition comprises: not greater than 0.40 wt. % silicon; not greater than 0.70 wt. % iron; from 0.05 wt. % to 0.30 wt. % copper; from 1.60 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 106: The method of any of clauses 92 to 103, wherein the aluminum alloy composition comprises: from 0.15 wt. % to 0.27 wt. % silicon; from 0.34 wt. % to 0.50 wt. % iron; from 0.14 wt. % to 0.24 wt. % copper; from 2.15 wt. % to 2.55 wt. % magnesium; from 0.67 wt. % to 0.83 wt. % manganese; from 0.008 wt. % to 0.055 wt. % titanium; not greater than 0.03 wt. % chromium; not greater than 0.12 wt. % Zn; not greater than 0.040 wt. % Ga; not greater than 0.15 wt. % other elements; and wherein the balance is aluminum.

Clause 107: The method of any of clauses 92 to 103, wherein the aluminum alloy composition comprises: from 0.17 wt. % to 0.25 wt. % silicon; from 0.38 wt. % to 0.48 wt. % iron; from 0.15 wt. % to 0.19 wt. % copper; from 2.30 wt. % to 2.50 wt. % magnesium; from 0.70 wt. % to 0.80 wt. % manganese; from 0.012 wt. % to 0.018 wt. % titanium; not greater than 0.02 wt. % chromium; not greater than 0.090 wt. % Zn; not greater than 0.015 wt. % Ga; not greater than 0.15 wt. % other elements; and wherein the balance is aluminum.

Clause 108: The method of any of clauses 92 to 103, wherein the aluminum alloy composition comprises: not greater than 0.40 wt. % silicon; not greater than 0.70 wt. % iron; from 0.05 wt. % to 0.30 wt. % copper; from 1.40 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 109: The method of any of clauses 92 to 103, wherein the aluminum alloy composition comprises: not greater than 0.40 wt. % silicon; not greater than 0.70 wt. % iron; from 0.05 wt. % to 0.30 wt. % copper; from 1.40 wt. % to 1.80 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 110: The method of any of clauses 92 to 103, wherein the aluminum alloy composition comprises: not greater than 0.40 wt. % silicon; not greater than 0.70 wt. % iron; from 0.05 wt. % to 0.30 wt. % copper; from 1.50 wt. % to 1.70 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 111: The method of any of clauses 92 to 103, wherein the aluminum alloy composition comprises: not greater than 0.40 wt. % silicon; not greater than 0.70 wt. % iron; from 0.05 wt. % to 0.30 wt. % copper; from 1.60 wt. % to 2.00 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 112: The method of any of clauses 92 to 103, wherein the aluminum alloy composition comprises: not greater than 0.40 wt. % silicon; not greater than 0.70 wt. % iron; from 0.05 wt. % to 0.30 wt. % copper; from 1.70 wt. % to 1.90 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 113: The method of any of clauses 92 to 103, wherein the aluminum alloy composition comprises: not greater than 0.40 wt. % silicon; not greater than 0.70 wt. % iron; from 0.05 wt. % to 0.30 wt. % copper; from 1.80 wt. % to 2.20 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 114: The method of any of clauses 92 to 103, wherein the aluminum alloy composition comprises: not greater than 0.40 wt. % silicon; not greater than 0.70 wt. % iron; from 0.05 wt. % to 0.30 wt. % copper; from 1.90 wt. % to 2.10 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 115: The method of any of clauses 92 to 103, wherein aluminum alloy composition comprises: not greater than 0.60 wt. % silicon; not greater than 0.80 wt. % iron; from 0.05 wt. % to 0.25 wt. % copper; from 0.80 wt. % to 1.30 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

Clause 116: The method of any of clauses 92 to 103, wherein the aluminum alloy composition comprises: from 0.15 wt. % to 0.27 wt. % silicon; from 0.45 wt. % to 0.55 wt. % iron; from 0.15 wt. % to 0.20 wt. % copper; from 1.10 wt. % to 1.23 wt. % magnesium; from 0.86 wt. % to 0.98 wt. % manganese; from 0.007 wt. % to 0.020 wt. % titanium; not greater than 0.020 wt. % chromium; not greater than 0.12 wt. % Zn; not greater than 0.040 wt. % Ga; not greater than 0.15 wt. % other elements; and wherein the balance is aluminum.

Clause 117: The method of any of clauses 92 to 103, wherein the aluminum alloy composition comprises: from 0.17 wt. % to 0.25 wt. % silicon; from 0.49 wt. % to 0.54 wt. % iron; from 0.17 wt. % to 0.19 wt. % copper; from 1.13 wt. % to 1.21 wt. % magnesium; from 0.89 wt. % to 0.96 wt. % manganese; from 0.009 wt. % to 0.018 wt. % titanium; not greater than 0.065 wt. % Zn; not greater than 0.015 wt. % Ga; not greater than 0.15 wt. % other elements; wherein the aluminum alloy composition is substantially free of chromium; and wherein the balance is aluminum.

Clause 118: The method of any of clause 92 to 103, wherein the aluminum alloy composition comprises: not greater than 0.60 wt. % silicon; greater than 0.80 wt. % iron; from 0.05 wt. % to 0.25 wt. % copper; from 0.80 wt. % to 1.40 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

Clause 119: The method of any of clauses 92 to 118, wherein the aluminum alloy sheet comprises a thickness of at least 0.006 inch.

Clause 120: The method of any of clauses 92 to 119, wherein the ultimate tensile strength of the aluminum alloy sheet is from 40 ksi to 52 ksi, or from 43 ksi to 52 ksi.

Clause 121: The method of any of clauses 92 to 119, wherein the ultimate tensile strength of the aluminum alloy sheet is from 38 ksi to 48 ksi, from 40 ksi to 45 ksi, from 37 ksi to 50 ksi, or from 37 ksi to 46 ksi.

Clause 122: The method of any of clauses 92 to 119, wherein the tensile yield strength of the aluminum alloy sheet is from 36 ksi to 47 ksi, or from 37 ksi to 46 ksi.

Clause 123: The method of any of clauses 92 to 119, wherein the tensile yield strength of the aluminum alloy sheet is from 35 ksi to 45 ksi, from 37 ksi to 43 ksi, from 34 ksi to 45 ksi, or from 34 ksi to 43 ksi.

Clause 124: The method of any of clauses 92 to 119, wherein the aluminum alloy sheet comprises a percent elongation of at least 4%.

Clause 125: The method of any of clauses 92 to 124, wherein the aluminum alloy sheet is a coated aluminum alloy sheet.

Clause 126: An aluminum alloy sheet comprising: an aluminum alloy composition comprising: a first component; and a second component; wherein the first component comprises recycled material, wherein the second component comprises non-recycled material; wherein the aluminum alloy composition comprises a recycled content of at least 50%; wherein the ultimate tensile strength of the aluminum alloy sheet is from 37 ksi to 52 ksi; wherein the tensile yield strength of the aluminum alloy sheet is from 34 ksi to 47 ksi; and wherein the aluminum alloy sheet is a coated aluminum alloy sheet.

Clause 127: The aluminum alloy sheet of claim 126, wherein the aluminum alloy composition further comprises a third component, wherein the third component comprises mill scrap.

Clause 128: The aluminum alloy sheet of clause 126, wherein the aluminum alloy composition comprises a recycled content of at least 70%.

Clause 129: The aluminum alloy sheet of clause 126, wherein the aluminum alloy composition comprises a recycled content of at least 75%.

Clause 130: The aluminum alloy sheet of clause 126, wherein the aluminum alloy composition comprises a recycled content of at least 80%, preferably at least 85%, more preferably at least 90%, most preferably 95%.

Clause 131: The aluminum alloy sheet of any of clauses 126 to 130, wherein the recycled material of the first component is selected from the group consisting of scrap Aluminum Association (AA) 5457, scrap AA 5754, scrap AA 5085, scrap AA 5083, scrap AA 5052, scrap AA 5154, scrap AA 5352, scrap AA 5182, scrap AA 5042, scrap AA 5086, post-industrial scrap, post-consumer scrap, Class I scrap, Class II scrap, Class III scrap, Class IV scrap, used beverage cans, and combinations thereof.

Clause 132: The aluminum alloy sheet of clause 131, wherein the recycled material comprises used beverage cans.

Clause 133: The aluminum alloy sheet of clause 131, wherein the recycled material comprises used beverage cans and scrap AA 5457.

Clause 134: The aluminum alloy sheet of any of clauses 126 to 133, wherein the non-recycled material of the second component comprises prime aluminum, an alloying element, or combinations thereof.

Clause 135: The aluminum alloy sheet of clause 134, wherein the alloying element is selected from the group consisting of silicon, iron, copper, magnesium, manganese, titanium, chromium, nickel, zinc, silver, boron, bismuth, gallium, lithium, lead, tin, vanadium, zirconium, and combinations thereof.

Clause 136: The aluminum alloy sheet of clause 127, wherein the mill scrap is selected from the group consisting of ingot scrap, casting scrap, remelted scrap ingot (RSI), hot roll processing scrap, cold roll processing scrap, uncoated coil scrap, coated coil, and combinations thereof.

Clause 137: The aluminum alloy sheet of any of clauses 126 to 136, wherein the aluminum alloy composition comprises: not greater than 0.60 wt. % silicon; not greater than 0.80 wt. % iron; from 0.05 wt. % to 0.30 wt. % copper; from 0.80 wt. % to 2.60 wt. % magnesium; from 0.60 wt. % to 1.40 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 138: The aluminum alloy sheet of any of clauses 126 to 136, wherein the aluminum alloy composition comprises: not greater than 0.40 wt. % silicon; not greater than 0.70 wt. % iron; from 0.05 wt. % to 0.30 wt. % copper; from 1.60 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 139: The aluminum alloy sheet of any of clauses 126 to 136, wherein the aluminum alloy composition comprises: from 0.15 wt. % to 0.27 wt. % silicon; from 0.34 wt. % to 0.50 wt. % iron; from 0.14 wt. % to 0.24 wt. % copper; from 2.15 wt. % to 2.55 wt. % magnesium; from 0.67 wt. % to 0.83 wt. % manganese; from 0.008 wt. % to 0.055 wt. % titanium; not greater than 0.12 wt. % Zn; not greater than 0.040 wt. % Ga; not greater than 0.03 wt. % chromium; not greater than 0.15 wt. % other elements; and wherein the balance is aluminum.

Clause 140: The aluminum alloy sheet of any of clauses 126 to 136, wherein the aluminum alloy composition comprises: from 0.17 wt. % to 0.25 wt. % silicon; from 0.38 wt. % to 0.48 wt. % iron; from 0.15 wt. % to 0.19 wt. % copper; from 2.30 wt. % to 2.50 wt. % magnesium; from 0.70 wt. % to 0.80 wt. % manganese; from 0.012 wt. % to 0.018 wt. % titanium; not greater than 0.090 wt. % Zn; not greater than 0.015 wt. % Ga; not greater than 0.02 wt. % chromium; not greater than 0.15 wt. % other elements; and wherein the balance is aluminum.

Clause 141: The aluminum alloy sheet of any of clauses 126 to 136, wherein the aluminum alloy composition comprises: not greater than 0.40 wt. % silicon; not greater than 0.70 wt. % iron; from 0.05 wt. % to 0.30 wt. % copper; from 1.40 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 142: The aluminum alloy sheet of any of clauses 126 to 136, wherein the aluminum alloy composition comprises: not greater than 0.40 wt. % silicon; not greater than 0.70 wt. % iron; from 0.05 wt. % to 0.30 wt. % copper; from 1.40 wt. % to 1.80 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 143: The aluminum alloy sheet of any of clauses 126 to 136, wherein the aluminum alloy composition comprises: not greater than 0.40 wt. % silicon; not greater than 0.70 wt. % iron; from 0.05 wt. % to 0.30 wt. % copper; from 1.50 wt. % to 1.70 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 144: The aluminum alloy sheet of any of clauses 126 to 136, wherein the aluminum alloy composition comprises: not greater than 0.40 wt. % silicon; not greater than 0.70 wt. % iron; from 0.05 wt. % to 0.30 wt. % copper; from 1.60 wt. % to 2.00 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 145: The aluminum alloy sheet of any of clauses 126 to 136, wherein the aluminum alloy composition comprises: not greater than 0.40 wt. % silicon; not greater than 0.70 wt. % iron; from 0.05 wt. % to 0.30 wt. % copper; from 1.70 wt. % to 1.90 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 146: The aluminum alloy sheet of any of clauses 126 to 136, wherein the aluminum alloy composition comprises: not greater than 0.40 wt. % silicon; not greater than 0.70 wt. % iron; from 0.05 wt. % to 0.30 wt. % copper; from 1.80 wt. % to 2.20 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 147: The aluminum alloy sheet of any of clauses 126 to 136, wherein the aluminum alloy composition comprises: not greater than 0.40 wt. % silicon; not greater than 0.70 wt. % iron; from 0.05 wt. % to 0.30 wt. % copper; from 1.90 wt. % to 2.10 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 148: The aluminum alloy sheet of any of clauses 126 to 136, wherein the aluminum alloy composition comprises: not greater than 0.60 wt. % silicon; not greater than 0.80 wt. % iron; from 0.05 wt. % to 0.25 wt. % copper; from 0.80 wt. % to 1.30 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

Clause 149: The aluminum alloy sheet of any of clauses 126 to 136, wherein the aluminum alloy composition comprises: from 0.15 wt. % to 0.27 wt. % silicon; from 0.45 wt. % to 0.55 wt. % iron; from 0.15 wt. % to 0.20 wt. % copper; from 1.10 wt. % to 1.23 wt. % magnesium; from 0.86 wt. % to 0.98 wt. % manganese; from 0.007 wt. % to 0.020 wt. % titanium; not greater than 0.12 wt. % Zn; not greater than 0.040 wt. % Ga; not greater than 0.020 wt. % chromium; not greater than 0.15 wt. % other elements; and wherein the balance is aluminum.

Clause 150: The aluminum alloy sheet of any of clauses 126 to 136, wherein the aluminum alloy composition comprises: from 0.17 wt. % to 0.25 wt. % silicon; from 0.49 wt. % to 0.54 wt. % iron; from 0.17 wt. % to 0.19 wt. % copper; from 1.13 wt. % to 1.21 wt. % magnesium; from 0.89 wt. % to 0.96 wt. % manganese; from 0.009 wt. % to 0.018 wt. % titanium; not greater than 0.065 wt. % Zn; not greater than 0.015 wt. % Ga; not greater than 0.15 wt. % other elements; wherein the aluminum alloy composition is substantially free of chromium; and wherein the balance is aluminum.

Clause 151: The aluminum alloy sheet of any of clause 126 to 136, wherein the aluminum alloy composition comprises: not greater than 0.60 wt. % silicon; greater than 0.80 wt. % iron; from 0.05 wt. % to 0.25 wt. % copper; from 0.80 wt. % to 1.40 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

Clause 152: The aluminum alloy sheet of any of clauses 126 to 151, wherein the ultimate tensile strength of the coated aluminum alloy sheet is from 40 ksi to 52 ksi or is from 43 ksi to 52 ksi.

Clause 153: The aluminum alloy sheet of any of clauses 126 to 151, wherein the ultimate tensile strength of the coated aluminum alloy sheet is from 37 ksi to 50 ksi, or from 37 ksi to 46 ksi.

Clause 154: The aluminum alloy sheet of any of clauses 126 to 151, wherein the tensile yield strength of the coated aluminum alloy sheet is from 36 ksi to 47 ksi or from 37 ksi to 46 ksi.

Clause 155: The aluminum alloy sheet of any of clauses 126 to 151, wherein the tensile yield strength of the coated aluminum alloy sheet is from 34 ksi to 45 ksi, or from 34 ksi to 43 ksi.

Clause 156: The aluminum alloy sheet of any of clauses 126 to 151, wherein the coated aluminum alloy sheet comprises a percent elongation is at least 4%.

Clause 157: The aluminum alloy sheet of any of clauses 126 to 156, wherein the thickness of the coated aluminum alloy sheet is at least 0.0060 inch.

Clause 158: A method of making an aluminum package, the method comprising: obtaining an aluminum alloy sheet, wherein the aluminum alloy sheet comprises an aluminum alloy composition comprising: first component; and a second component; wherein the first component comprises recycled material, wherein the second component comprises non-recycled material, and wherein the aluminum alloy composition comprises a recycled content of at least 50%; wherein the ultimate tensile strength of the aluminum alloy sheet is from 37 ksi to 52 ksi; and wherein the tensile yield strength of the aluminum alloy sheet is from 34 ksi to 47 ksi; coating the aluminum alloy sheet to form a coated aluminum alloy sheet; and forming the coated aluminum alloy sheet into an aluminum alloy package.

Clause 159: The method of clause 158, wherein the aluminum alloy composition further comprises a third component, wherein the third component comprises mill scrap.

Clause 160: The method of clause 158, wherein the aluminum package is for processed food applications.

Clause 161: The method of clause 158, wherein the aluminum alloy composition comprises a recycled content of at least 70%.

Clause 162: The method of clause 158, wherein the aluminum alloy composition comprises a recycled content of at least 75%.

Clause 163: The method of clause 158, wherein the aluminum alloy composition comprises a recycled content of at least 80%, preferably at least 85%, more preferably at least 90%, most preferably 95%.

Clause 164: The method of any of clauses 158 to 163, wherein the recycled material of the first component is selected from the group consisting of scrap Aluminum Association (AA) 5457, scrap AA 5754, scrap AA 5085, scrap AA 5083, scrap AA 5052, scrap AA 5154, scrap AA 5352, scrap AA 5182, scrap AA 5042, scrap AA 5086, post-industrial scrap, post-consumer scrap, Class I scrap, Class II scrap, Class III scrap, Class IV scrap, used beverage cans, and combinations thereof.

Clause 165: The method of clause 164, wherein the recycled material comprises used beverage cans.

Clause 166: The method of clause 164, wherein the recycled material comprises used beverage cans and scrap AA 5457.

Clause 167: The method of any of clauses 158 to 166, wherein the non-recycled material of the second component comprises prime aluminum, an alloy component, or combinations thereof.

Clause 168: The method of clause 167, wherein the alloying element is selected from the group consisting of silicon, iron, copper, magnesium, manganese, titanium, chromium, nickel, zinc, silver, boron, bismuth, gallium, lithium, lead, tin, vanadium, zirconium, and combinations thereof.

Clause 169: The method of clause 159, wherein the mill scrap is selected from the group consisting of ingot scrap, casting scrap, remelted scrap ingot (RSI), hot roll processing scrap, cold roll processing scrap, uncoated coil scrap, coated coil, and combinations thereof.

Clause 170: The method of any of clauses 158 to 169, wherein the aluminum alloy composition comprises: not greater than 0.60 wt. % silicon; not greater than 0.80 wt. % iron; from 0.05 wt. % to 0.30 wt. % copper; from 0.80 wt. % to 2.60 wt. % magnesium; from 0.60 wt. % to 1.40 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 171: The method of any of clauses 158 to 169, wherein the aluminum alloy composition comprises: not greater than 0.40 wt. % silicon; not greater than 0.70 wt. % iron; from 0.05 wt. % to 0.30 wt. % copper; from 1.60 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 172: The method of any of clauses 158 to 169, wherein the aluminum alloy composition comprises: from 0.15 wt. % to 0.27 wt. % silicon; from 0.34 wt. % to 0.50 wt. % iron; from 0.14 wt. % to 0.24 wt. % copper; from 2.15 wt. % to 2.55 wt. % magnesium; from 0.67 wt. % to 0.83 wt. % manganese; from 0.008 wt. % to 0.055 wt. % titanium; not greater than 0.03 wt. % chromium; not greater than 0.12 wt. % Zn; not greater than 0.040 wt. % Ga; not greater than 0.15 wt. % other elements; and wherein the balance is aluminum.

Clause 173: The method of any of clauses 158 to 169, wherein the aluminum alloy composition comprises: from 0.17 wt. % to 0.25 wt. % silicon; from 0.38 wt. % to 0.48 wt. % iron; from 0.15 wt. % to 0.19 wt. % copper; from 2.30 wt. % to 2.50 wt. % magnesium; from 0.70 wt. % to 0.80 wt. % manganese; from 0.012 wt. % to 0.018 wt. % titanium; not greater than 0.02 wt. % chromium; not greater than 0.090 wt. % Zn; not greater than 0.015 wt. % Ga; not greater than 0.15 wt. % other elements; and wherein the balance is aluminum.

Clause 174: The method of any of clauses 158 to 169, wherein the aluminum alloy composition comprises: not greater than 0.40 wt. % silicon; not greater than 0.70 wt. % iron; from 0.05 wt. % to 0.30 wt. % copper; from 1.40 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 175: The method of any of clauses 158 to 169, wherein the aluminum alloy composition comprises: not greater than 0.40 wt. % silicon; not greater than 0.70 wt. % iron; from 0.05 wt. % to 0.30 wt. % copper; from 1.40 wt. % to 1.80 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 176: The method of any of clauses 158 to 169, wherein the aluminum alloy composition comprises: not greater than 0.40 wt. % silicon; not greater than 0.70 wt. % iron; from 0.05 wt. % to 0.30 wt. % copper; from 1.50 wt. % to 1.70 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 177: The method of any of clauses 158 to 169, wherein the aluminum alloy composition comprises: not greater than 0.40 wt. % silicon; not greater than 0.70 wt. % iron; from 0.05 wt. % to 0.30 wt. % copper; from 1.60 wt. % to 2.00 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 178: The method of any of clauses 158 to 169, wherein the aluminum alloy composition comprises: not greater than 0.40 wt. % silicon; not greater than 0.70 wt. % iron; from 0.05 wt. % to 0.30 wt. % copper; from 1.70 wt. % to 1.90 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 179: The method of any of clauses 158 to 169, wherein the aluminum alloy composition comprises: not greater than 0.40 wt. % silicon; not greater than 0.70 wt. % iron; from 0.05 wt. % to 0.30 wt. % copper; from 1.80 wt. % to 2.20 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 180: The method of any of clauses 158 to 169, wherein the aluminum alloy composition comprises: not greater than 0.40 wt. % silicon; not greater than 0.70 wt. % iron; from 0.05 wt. % to 0.30 wt. % copper; from 1.90 wt. % to 2.10 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 181: The method of any of clauses 158 to 169, wherein aluminum alloy composition comprises: not greater than 0.60 wt. % silicon; not greater than 0.80 wt. % iron; from 0.05 wt. % to 0.25 wt. % copper; from 0.80 wt. % to 1.30 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

Clause 182: The method of any of clauses 158 to 169, wherein the aluminum alloy composition comprises: from 0.15 wt. % to 0.27 wt. % silicon; from 0.45 wt. % to 0.55 wt. % iron; from 0.15 wt. % to 0.20 wt. % copper; from 1.10 wt. % to 1.23 wt. % magnesium; from 0.86 wt. % to 0.98 wt. % manganese; from 0.007 wt. % to 0.020 wt. % titanium; not greater than 0.020 wt. % chromium; not greater than 0.12 wt. % Zn; not greater than 0.040 wt. % Ga; not greater than 0.15 wt. % other elements; and wherein the balance is aluminum.

Clause 183: The method of any of clauses 158 to 169, wherein the aluminum alloy composition comprises: from 0.17 wt. % to 0.25 wt. % silicon; from 0.49 wt. % to 0.54 wt. % iron; from 0.17 wt. % to 0.19 wt. % copper; from 1.13 wt. % to 1.21 wt. % magnesium; from 0.89 wt. % to 0.96 wt. % manganese; from 0.009 wt. % to 0.018 wt. % titanium; not greater than 0.065 wt. % Zn; not greater than 0.015 wt. % Ga; not greater than 0.15 wt. % other elements; wherein the aluminum alloy composition is substantially free of chromium; and wherein the balance is aluminum.

Clause 184: The method of any of clause 158 to 169, wherein the aluminum alloy composition comprises: not greater than 0.60 wt. % silicon; greater than 0.80 wt. % iron; from 0.05 wt. % to 0.25 wt. % copper; from 0.80 wt. % to 1.40 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

Clause 185: The method of any of clauses 158 to 184, wherein the aluminum alloy sheet comprises a thickness of at least 0.006 inch.

Clause 186: The method of any of clauses 158 to 185, wherein the ultimate tensile strength of the coated aluminum alloy sheet is from 40 ksi to 52 ksi, or from 43 ksi to 52 ksi.

Clause 187: The method of any of clauses 158 to 185, wherein the ultimate tensile strength of the coated aluminum alloy sheet is from 37 ksi to 50 ksi, or from 37 ksi to 46 ksi.

Clause 188: The method of any of clauses 158 to 185, wherein the tensile yield strength of the coated aluminum alloy sheet is from 36 ksi to 47 ksi, or from 37 ksi to 46 ksi.

Clause 189: The method of any of clauses 158 to 185, wherein the tensile yield strength of the coated aluminum alloy sheet is from 34 ksi to 45 ksi, or from 34 ksi to 43 ksi.

Clause 190: The method of any of clauses 158 to 185, wherein the coated aluminum alloy sheet comprises a percent elongation of at least 4%.

Clause 191: A method of making an aluminum alloy composition, the method comprising: obtaining a first component, wherein the first component comprises recycled material; obtaining a second component, wherein the second component comprises non-recycled material; melting the first component; melting the second component; and blending the first component and the second component together to form the aluminum alloy composition, wherein the aluminum alloy composition comprises a recycled content of at least 50%, and comprises: not greater than 0.60 wt. % silicon; not greater than 0.80 wt. % iron; from 0.05 wt. % to 0.30 wt. % copper; from 0.80 wt. % to 2.60 wt. % magnesium; from 0.60 wt. % to 1.40 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 192: The method of clause 191, further comprising: obtaining a third component, wherein the third component comprises mill scrap; melting the third component; and blending the third component with the first component and the second component to form an aluminum alloy composition.

Clause 193: The method of clause 191, wherein the aluminum alloy composition comprises a recycled content of at least 70%.

Clause 194: The method of clause 191, wherein the aluminum alloy composition comprises a recycled content of at least 75%.

Clause 195: The method of clause 191, wherein the aluminum alloy composition comprises a recycled content of at least 80%, preferably at least 85%, more preferably at least 90%, most preferably 95%.

Clause 196: The method of any of clauses 191 to 195, wherein the recycled material is selected from the group consisting of scrap Aluminum Association (AA) 5457, scrap AA 5754, scrap AA 5085, scrap AA 5083, scrap AA 5052, scrap AA 5154, scrap AA 5352, scrap AA 5182, scrap AA 5042, scrap AA 5086, post-industrial scrap, post-consumer scrap, Class I scrap, Class II scrap, Class III scrap, Class IV scrap, used beverage cans, and combinations thereof.

Clause 197: The method of clause 196, wherein the recycled material comprises used beverage cans.

Clause 198: The method of clause 196, wherein the recycled material comprises used beverage cans and scrap AA 5457.

Clause 199: The method of any of clauses 191 to 198, wherein the non-recycled material of the second component comprises prime aluminum, an alloying element, or combinations thereof.

Clause 200: The method of clause 199, wherein the alloying element is selected from the group consisting of silicon, iron, copper, magnesium, manganese, titanium, chromium, nickel, zinc, silver, boron, bismuth, gallium, lithium, lead, tin, vanadium, zirconium, and combinations thereof.

Clause 201: The method of clause 192, wherein the mill scrap is selected from the group consisting of ingot scrap, casting scrap, remelted scrap ingot (RSI), hot roll processing scrap, cold roll processing scrap, uncoated coil scrap, coated coil, and combinations thereof.

Clause 202: The method of any of clauses 191 to 201, wherein the aluminum alloy composition comprises: not greater than 0.40 wt. % silicon; not greater than 0.70 wt. % iron; from 0.05 wt. % to 0.30 wt. % copper; from 1.60 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 203: The method of any of clauses 191 to 201, wherein the aluminum alloy composition comprises: from 0.15 wt. % to 0.27 wt. % silicon; from 0.34 wt. % to 0.50 wt. % iron; from 0.14 wt. % to 0.24 wt. % copper; from 2.15 wt. % to 2.55 wt. % magnesium; from 0.67 wt. % to 0.83 wt. % manganese; from 0.008 wt. % to 0.055 wt. % titanium; not greater than 0.03 wt. % chromium; not greater than 0.12 wt. % Zn; not greater than 0.040 wt. % Ga; not greater than 0.15 wt. % other elements; and wherein the balance is aluminum.

Clause 204: The method of any of clauses 191 to 201, wherein the aluminum alloy composition comprises: from 0.17 wt. % to 0.25 wt. % silicon; from 0.38 wt. % to 0.48 wt. % iron; from 0.15 wt. % to 0.19 wt. % copper; from 2.30 wt. % to 2.50 wt. % magnesium; from 0.70 wt. % to 0.80 wt. % manganese; from 0.012 wt. % to 0.018 wt. % titanium; not greater than 0.02 wt. % chromium; not greater than 0.090 wt. % Zn; not greater than 0.015 wt. % Ga; not greater than 0.15 wt. % other elements; and wherein the balance is aluminum.

Clause 205: The method of any of clauses 191 to 201, wherein the aluminum alloy composition comprises: not greater than 0.40 wt. % silicon; not greater than 0.70 wt. % iron; from 0.05 wt. % to 0.30 wt. % copper; from 1.40 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 206: The method of any of clauses 191 to 201, wherein the aluminum alloy composition comprises: not greater than 0.40 wt. % silicon; not greater than 0.70 wt. % iron; from 0.05 wt. % to 0.30 wt. % copper; from 1.40 wt. % to 1.80 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 207: The method of any of clauses 191 to 201, wherein the aluminum alloy composition comprises: not greater than 0.40 wt. % silicon; not greater than 0.70 wt. % iron; from 0.05 wt. % to 0.30 wt. % copper; from 1.50 wt. % to 1.70 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 208: The method of any of clauses 191 to 201, wherein the aluminum alloy composition comprises: not greater than 0.40 wt. % silicon; not greater than 0.70 wt. % iron; from 0.05 wt. % to 0.30 wt. % copper; from 1.60 wt. % to 2.00 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 209: The method of any of clauses 191 to 201, wherein the aluminum alloy composition comprises: not greater than 0.40 wt. % silicon; not greater than 0.70 wt. % iron; from 0.05 wt. % to 0.30 wt. % copper; from 1.70 wt. % to 1.90 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 210: The method of any of clauses 191 to 201, wherein the aluminum alloy composition comprises: not greater than 0.40 wt. % silicon; not greater than 0.70 wt. % iron; from 0.05 wt. % to 0.30 wt. % copper; from 1.80 wt. % to 2.20 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 211: The method of any of clauses 191 to 201, wherein the aluminum alloy composition comprises: not greater than 0.40 wt. % silicon; not greater than 0.70 wt. % iron; from 0.05 wt. % to 0.30 wt. % copper; from 1.90 wt. % to 2.10 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

Clause 212: The method of any of clauses 191 to 201, wherein the aluminum alloy composition comprises: not greater than 0.60 wt. % silicon; not greater than 0.80 wt. % iron; from 0.05 wt. % to 0.25 wt. % copper; from 0.80 wt. % to 1.30 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

Clause 213: The method of any of clauses 191 to 201, wherein the aluminum alloy composition comprises: from 0.15 wt. % to 0.27 wt. % silicon; from 0.45 wt. % to 0.55 wt. % iron; from 0.15 wt. % to 0.20 wt. % copper; from 1.10 wt. % to 1.23 wt. % magnesium; from 0.86 wt. % to 0.98 wt. % manganese; from 0.007 wt. % to 0.020 wt. % titanium; not greater than 0.020 wt. % chromium; not greater than 0.12 wt. % Zn; not greater than 0.040 wt. % Ga; not greater than 0.15 wt. % other elements; wherein the balance is aluminum.

Clause 214: The method of any of clauses 191 to 201, wherein the aluminum alloy composition comprises: from 0.17 wt. % to 0.25 wt. % silicon; from 0.49 wt. % to 0.54 wt. % iron; from 0.17 wt. % to 0.19 wt. % copper; from 1.13 wt. % to 1.21 wt. % magnesium; from 0.89 wt. % to 0.96 wt. % manganese; from 0.009 wt. % to 0.018 wt. % titanium; not greater than 0.065 wt. % Zn; not greater than 0.015 wt. % Ga; not greater than 0.15 wt. % other elements; wherein the aluminum alloy composition is substantially free of chromium; and wherein the balance is aluminum.

Clause 215: The method of any of clause 191 to 201, wherein the aluminum alloy composition comprises: not greater than 0.60 wt. % silicon; greater than 0.80 wt. % iron; from 0.05 wt. % to 0.25 wt. % copper; from 0.80 wt. % to 1.40 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

### EXAMPLES

### Example 1

An aluminum alloy composition (Aluminum Alloy 1) was prepared having a recycled content of 80%. The recycled material in Aluminum Alloy 1 was UBC. The non-recycled material in Aluminum Alloy 1 was prime aluminum and an alloying element. Mill scrap was included and was internally generated. The recycled content of Aluminum Alloy 1 was calculated based on the total amount of recycled material and the total amount of non-recycled material. The mill scrap was not included in the calculation for recycled content as indicated by the Aluminum Association. The UBC, prime aluminum, alloying components, and the mill scrap were melted and blended to form the Aluminum Alloy 1 composition. Aluminum Alloy 1 was then cast into ingots. The weight percentages of the first component, second component, and third component used to generate Aluminum Alloy 1 can be found in Table 1.

TABLE 1

| | | Weight |
|---|---|---|
| | | Percent |
| Component | Metal Type | (wt. %) |
| First Component | UBC | 70.5 wt. % |
| Second Component | Prime Aluminum | 17.5 wt. % |
| | Alloying Elements | |
| Third Component | Mill Scrap | 12.0 wt. % |

The resulting aluminum alloy composition formed from the combination of the first component, the second component, and the third component of Aluminum Alloy 1 had the following elemental composition, based on 100 wt. %, as provided in Table 2. Prophetic Aluminum Alloys 3-5, that will be prepared using the components described in Table 1, are also provided in Table 2.

TABLE 2

| | | Prophetic | Prophetic | Prophetic |
|---|---|---|---|---|
| | Aluminum | Aluminum | Aluminum | Aluminum |
| | Alloy 1 | Alloy 3 | Alloy 4 | Alloy 5 |
| | Elemental | Elemental | Elemental | Elemental |
| | Composition | Composition | Composition | Composition |
| Element | (wt. %) | (wt. %) | (wt. %) | (wt. %) |
| Si | 0.20 | 0.20 | 0.20 | 0.20 |
| Fe | 0.47 | 0.47 | 0.47 | 0.47 |
| Cu | 0.16 | 0.16 | 0.16 | 0.16 |
| Mg | 2.40 | 1.60 | 1.80 | 2.00 |
| Mn | 0.72 | 0.72 | 0.72 | 0.72 |
| Ti | 0.0150 | 0.0150 | 0.0150 | 0.0150 |
| Cr | 0.013 | 0.013 | 0.013 | 0.013 |
| Zn | 0.088 | 0.088 | 0.088 | 0.088 |
| Ga | 0.014 | 0.014 | 0.014 | 0.014 |
| Ca | 0.0026 | 0.0026 | 0.0026 | 0.0026 |
| Na | 0.0008 | 0.0008 | 0.0008 | 0.0008 |
| Al | Balance | Balance | Balance | Balance |

An ingot of Aluminum Alloy 1 was hot rolled to obtain an intermediate aluminum alloy sheet. The intermediate aluminum alloy sheet was then cold rolled to obtain an aluminum alloy sheet having a thickness of approximately 0.0080 inches. The aluminum alloy sheet was collected as coil and had a H1 temper (Aluminum Alloy 1-1). A second aluminum alloy sheet was collected as a coil and further processed to obtain a temper of H2 (Aluminum Alloy 1-2). Aluminum Alloy 1-1 and Aluminum Alloy 1-2 sheets were coated on both sides with a coating composition and were baked to cure the coating composition. The resulting mechanical properties of the coated aluminum alloy sheets can be found in Table 3. A commercially available AA 5042 aluminum alloy sheet was used as a reference, where the AA 5042 had an average recycled content of 46% and was coated on both sides with the same coating composition (Reference 1-1).

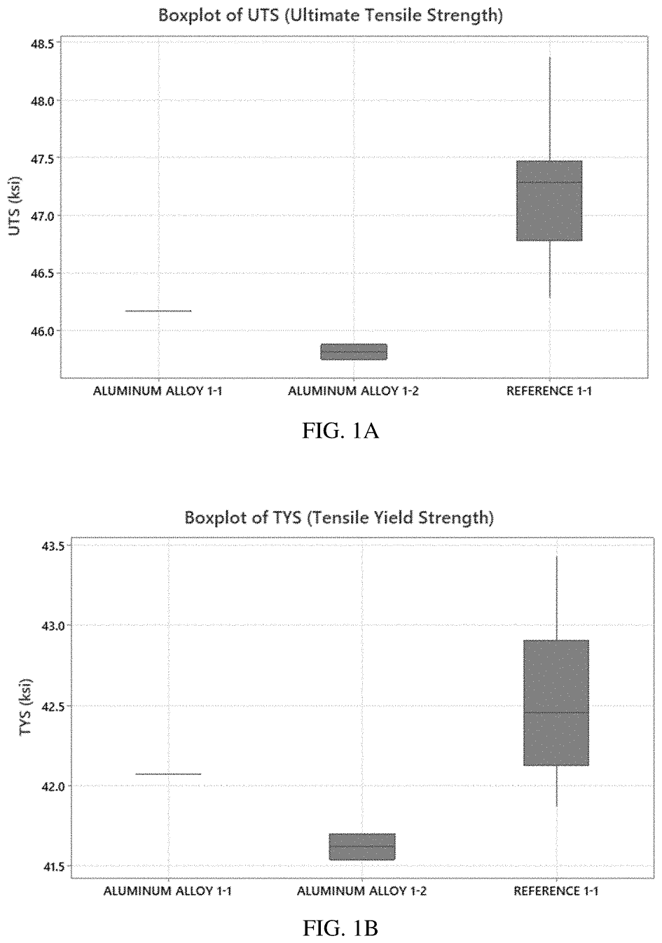

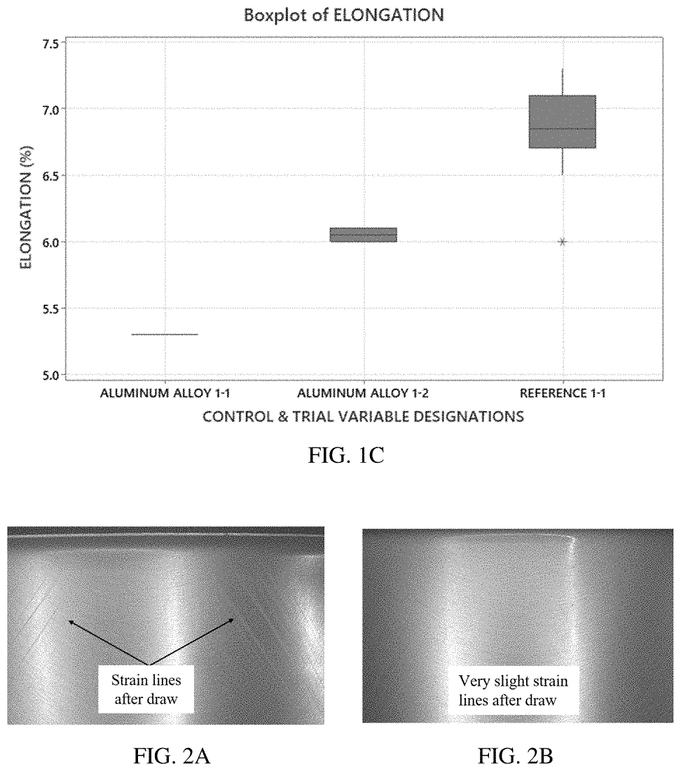

The resulting UTS, TYS, and percent elongation values for Aluminum Alloy 1-1, Aluminum Alloy 1-2, and Reference 1-1 are provided in Table 3. Reference 1-1 in Table 3 is an average value of four different coil samples. A comparison of the UTS of Aluminum Alloy 1-1, Aluminum Alloy 1-2, and Reference 1-1 can be found in FIG. 1A. A comparison of the TYS of Aluminum Alloy 1-1, Aluminum Alloy 1-2, and Reference 1-1 can be found in FIG. 1B. A comparison of the percent elongation of Aluminum Alloy 1-1, Aluminum Alloy 1-2, and Reference 1-1 can be found in FIG. 1C.

TABLE 3

| Sample | UTS (ksi) | TYS (ksi) | % Elongation (%) |
|---|---|---|---|
| Reference 1-1 | 47.40 | 42.70 | 6.96 |
| Aluminum Alloy 1-1 | 46.17 | 42.07 | 5.3 |
| Aluminum Alloy 1-2 | 45.82 | 41.62 | 6.05 |

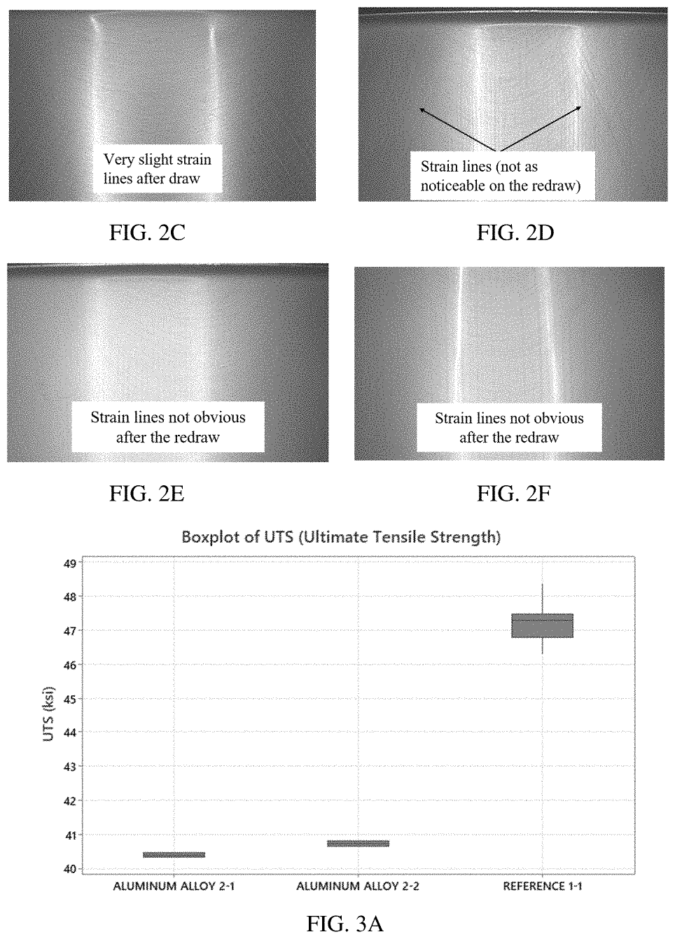

Cups were drawn from a sheet of Aluminum Alloy 1-1, Aluminum Alloy 1-2, and Reference 1-1. The cups drawn from Reference 1-1 had strain lines at the top portion of the cup, as shown in FIG. 2A. The cups formed from Aluminum Alloy 1-1 and Aluminum Alloy 1-2 had very light strain lines at the top portion of the cup, as shown in FIGS. 2B and 2C, respectively. The cups formed from Aluminum Alloy 1-1, Aluminum Alloy 1-2, and Reference 1-1 were then redrawn. The redrawn cups from Reference 1-1 had strain lines at the top portion of the redrawn cup that were not as noticeable as compared to after the initial draw, as shown in FIG. 2D. The redrawn cups formed from Aluminum Alloy 1-1 and Aluminum Alloy 1-2 had no obvious strain lines at the top portion of the cup after re-drawing, as shown in FIGS. 2E and 2F.

### Example 2

An aluminum alloy composition (Aluminum Alloy 2) was prepared having a recycled content of 70%. The recycled material in Aluminum Alloy 2 was UBC. The non-recycled material in Aluminum Alloy 2 included prime aluminum and an alloying element. Mill scrap was included and was internally generated. The recycled content of Aluminum Alloy 2 was calculated based on the total amount of recycled material and the total amount of non-recycled material. The mill scrap was not included in the calculation for recycled content. The UBC and pure aluminum were in a molten state. The mill scrap and alloying element were added to the molten mixture as solid components. Aluminum Alloy 2 was then cast into ingots. The weight percentages of the first component, the second component, and the third component of Aluminum Alloy 2 can be found in Table 4.

TABLE 4

| | | Weight |
|---|---|---|
| | | Percentage |
| Component | Metal Type | (wt. %) |
| First Component | UBC | 50.2 wt. % |
| Second Component | Prime Aluminum | 21.9 wt. % |
| | Alloying Elements | |
| Third Component | Mill Scrap | 27.9 wt. % |

The resulting aluminum alloy composition formed from the combination of the first component, the second component, and the third component had the following elemental composition, based in 100 wt. %, as provided in Table 5.

TABLE 5

| | Aluminum |
|---|---|
| | Alloy 2 |
| | Elemental |
| | Composition |
| Element | (wt. %) |
| Si | 0.22 |
| Fe | 0.51 |
| Cu | 0.18 |
| Mg | 1.15 |
| Mn | 0.95 |
| Ti | 0.013 |
| Cr | 0.01 |
| Zn | 0.062 |
| Ga | 0.013 |
| Ca | 0.0028 |
| Na | 0.0010 |
| Al | Balance |

An ingot of Aluminum Alloy 2 was hot rolled to obtain an intermediate aluminum alloy sheet. The intermediate aluminum alloy sheet was then cold rolled to obtain an aluminum alloy sheet having a thickness of approximately 0.0080 inches. The aluminum alloy sheet was collected as coil and had a H1 temper (Aluminum Alloy 2-1). A second aluminum alloy sheet was collected as a coil and was further processed to obtain a temper of H2 (Aluminum Alloy 2-2). Aluminum Alloy 2-1 and Aluminum Alloy 2-2 sheets were coated on both sides with a coating composition and were baked to cure the coating composition. The control was the same control as provided in Example 1.

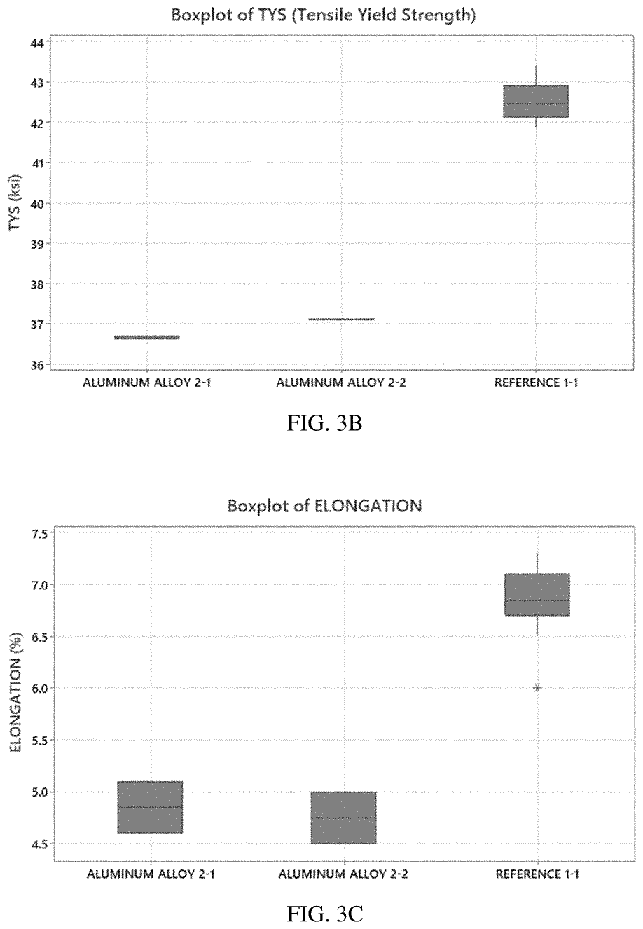

The resulting UTS, TYS, and percent elongation values for Aluminum Alloy 2-1, Aluminum Alloy 2-2, and Reference 1-1 are provided in Table 6. A comparison of the UTS of Aluminum Alloy 2-1, Aluminum Alloy 2-2, and Reference 1-1 can be found in FIG. 3A. A comparison of the TYS of Aluminum Alloy 2-1, Aluminum Alloy 2-2, and Reference 1-1 can be found in FIG. 3B. A comparison of the percent elongation of Aluminum Alloy 2-1, Aluminum Alloy 2-2, and Reference 1-1 can be found in FIG. 3C.

TABLE 6

| Sample | UTS (ksi) | TYS (ksi) | % Elongation |
|---|---|---|---|
| Reference 1-1 | 47.40 | 42.70 | 6.96 |
| Aluminum Alloy 2-1 | 40.40 | 36.66 | 4.85 |
| Aluminum Alloy 2-2 | 40.74 | 37.11 | 4.75 |

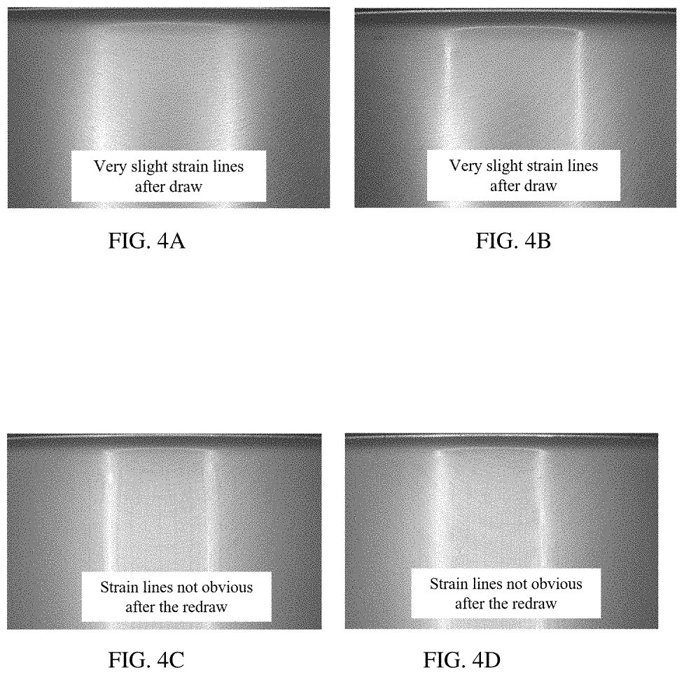

Cups were drawn from a sheet of Aluminum Alloy 2-1, Aluminum Alloy 2-2, and Reference 1-1. The cups drawn from Reference 1-1 had strain lines at the top portion of the cup, as shown in FIG. 2A. The cups formed from Aluminum Alloy 2-1 and Aluminum Alloy 2-2 had very light strain lines at the top portion of the cup, as shown in FIGS. 4B and 4C, respectively. The cups formed from Aluminum Alloy 2-1, Aluminum Alloy 2-2, and Reference 1-1 were redrawn. The redrawn cups from Reference 1-1 had strain lines at the top portion of the redrawn cup that were not as noticeable as compared to after the initial draw, as shown in FIG. 2D. The redrawn cups formed from Aluminum Alloy 2-1 and Aluminum Alloy 2-2 had no obvious strain lines at the top portion of the cup after re-drawing, as shown in FIGS. 4D and 4E.

It will be readily appreciated by those skilled in the art that modification may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

The invention claimed is:

1. An aluminum alloy sheet comprising:
an aluminum alloy composition comprising:
a first component; and
a second component;
wherein the first component comprises recycled material,
wherein the second component comprises non-recycled material, and
wherein the aluminum alloy composition comprises a recycled content of at least 50%;
wherein the ultimate tensile strength of the aluminum alloy sheet is from 37 to 52 ksi; and
wherein the tensile yield strength of the aluminum alloy sheet is from 34 ksi to 47 ksi.

2. The aluminum alloy sheet of claim 1, wherein the aluminum alloy composition further comprises a third component,
wherein the third component comprises mill scrap selected from the group consisting of ingot scrap, casting scrap, remelted scrap ingot (RSI), hot roll processing scrap, cold roll processing scrap, uncoated coil scrap, coated coil, and combinations thereof.

3. The aluminum alloy sheet of claim 1, wherein the aluminum alloy composition comprises a recycled content of at least 70%.

4. The aluminum alloy sheet of claim 1, wherein the recycled material of the first component is selected from the group consisting of scrap Aluminum Association (AA) 5457, scrap AA 5754, scrap AA 5085, scrap AA 5083, scrap AA 5086, scrap AA 5052, scrap AA 5154, scrap AA 5352, scrap AA 5182, scrap AA 5042, post-industrial scrap, post-consumer scrap, Class I scrap, Class II scrap, Class III scrap, Class IV scrap, used beverage cans, and combinations thereof.

5. The aluminum alloy sheet of claim 1, wherein the non-recycled material of the second component comprises prime aluminum, an alloying element or combinations thereof,
wherein the alloying element is selected from the group consisting of silicon, iron, copper, magnesium, manganese, titanium, chromium, nickel, zinc, silver, boron, bismuth, gallium, lithium, lead, tin, vanadium, zirconium, and combinations thereof.

6. The aluminum alloy sheet of claim 1, wherein the aluminum alloy composition comprises: not greater than 0.60 wt. % silicon; not greater than 0.80 wt. % iron; from 0.05 wt. % to 0.30 wt. % copper; from 0.80 wt. % to 2.60 wt. % magnesium; from 0.60 wt. % to 1.40 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

7. The aluminum alloy sheet of claim 1, wherein the aluminum alloy composition comprises: not greater than 0.40 wt. % silicon; not greater than 0.70 wt. % iron; from 0.05 wt. % to 0.30 wt. % copper; from 1.40 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

8. The aluminum alloy sheet of claim 1, wherein the aluminum alloy composition comprises: not greater than 0.60 wt. % silicon; not greater than 0.80 wt. % iron; from 0.05 wt. % to 0.25 wt. % copper; from 0.80 wt. % to 1.40 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

9. The aluminum alloy sheet of claim 1, wherein the ultimate tensile strength of the aluminum alloy sheet is from 43 ksi to 52 ksi,
wherein the tensile yield strength of the aluminum alloy sheet is from 37 ksi to 46 ksi, and
wherein the aluminum alloy sheet comprises a percent elongation of at least 4%.

10. The aluminum alloy sheet of claim 1, wherein the ultimate tensile strength of the aluminum alloy sheet is from 37 ksi to 50 ksi
wherein the tensile yield strength of the aluminum alloy is from 34 ksi to 43 ksi, and
wherein the aluminum alloy sheet comprises a percent elongation of at least 4%.

11. An aluminum alloy composition comprising:
a first component; and
a second component;
wherein the first component comprises recycled material,
wherein the second component comprises non-recycled material,
wherein the aluminum alloy composition comprises a recycled content of at least 50%, and comprises: not greater than 0.60 wt. % silicon; not greater than 0.80 wt. % iron; from 0.05 wt. % to 0.30 wt. % copper; from 0.80 wt. % to 2.60 wt. % magnesium; from 0.60 wt. % to 1.40 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

12. The aluminum alloy composition of claim 11, further comprising a third component,
wherein the third component comprises mill scrap selected from the group consisting of ingot scrap, casting scrap, remelted scrap ingot (RSI), hot roll processing scrap, cold roll processing scrap, uncoated coil scrap, coated coil, and combinations thereof.

13. The aluminum alloy composition of claim 11, wherein the aluminum alloy composition comprises a recycled content of at least 70%.

14. The aluminum alloy composition of claim 11, wherein the recycled material is selected from the group consisting of scrap Aluminum Association (AA) 5457, scrap AA 5754, scrap AA 5085, scrap AA 5083, scrap AA 5052, scrap AA 5154, scrap AA 5352, scrap AA 5182, scrap AA 5042, scrap AA 5086, post-industrial scrap, post-consumer scrap, Class I scrap, Class II scrap, Class III scrap, Class IV scrap, used beverage cans, and combinations thereof.

15. The aluminum alloy composition of claim 11, wherein the non-recycled material of the second component comprises prime aluminum, an alloying element, or combinations thereof,
wherein the alloying element is selected from the group consisting of silicon, iron, copper, magnesium, manganese, titanium, chromium, nickel, zinc, silver, boron, bismuth, gallium, lithium, lead, tin, vanadium, zirconium, and combinations thereof.

16. The aluminum alloy composition of claim 11, wherein the aluminum alloy composition comprises: not greater than 0.40 wt. % silicon; not greater than 0.70 wt. % iron; from 0.05 wt. % to 0.30 wt. % copper; from 1.40 wt. % to 2.60 wt. % magnesium; from 0.60 wt. % to 1.10 wt. % manganese; not greater than 0.10 wt. % titanium; not greater than 0.30 wt. % chromium; not greater than 0.30 wt. % Zn; not greater than 0.050 wt. % Ga; not greater than 0.15 wt. % other elements; and wherein the balance is aluminum.

17. The aluminum alloy composition of claim 11, wherein the aluminum alloy composition comprises: not greater than 0.60 wt. % silicon; not greater than 0.80 wt. % iron; from 0.05 wt. % to 0.25 wt. % copper; from 0.80 wt. % to 1.40 wt. % magnesium; from 0.80 wt. % to 1.40 wt. % manganese; not greater than 0.10 wt. % titanium; not greater than 0.25 wt. % Zn; not greater than 0.050 wt. % Ga; not greater than 0.15 wt. % other elements; wherein the aluminum alloy composition is substantially free of chromium; and wherein the balance is aluminum.

18. A method of making an aluminum package, the method comprising:
obtaining an aluminum alloy sheet, wherein the aluminum alloy sheet comprises an aluminum alloy composition comprising:
a first component; and
a second component;
wherein the first component comprises recycled material,
wherein the second component comprises non-recycled material, and
wherein the aluminum alloy composition comprises a recycled content of at least 50%;
wherein the ultimate tensile strength of the aluminum alloy sheet is from 37 ksi to 52 ksi; and
wherein the tensile yield strength of the aluminum alloy sheet is from 34 ksi to 47 ksi; and
forming the aluminum alloy sheet into an aluminum alloy package.

19. The method of claim 18, wherein the aluminum alloy composition further comprises a third component, and
wherein the third component comprises mill scrap selected from the group consisting of ingot scrap, casting scrap, remelted scrap ingot (RSI), hot roll processing scrap, cold roll processing scrap, uncoated coil scrap, coated coil, and combinations thereof.

20. The method of claim 18, wherein the aluminum package is for processed food applications.
